(19) United States
(12) Patent Application Publication
(10) Pub. No.: US 2026/0315961 A1
(43) Pub. Date: Oct. 15, 2026

(54) COMPOSITIONS OF CATIONIC POLYACRYLAMIDES, CATIONIC POLYMER-SUFACTANT AGGREGATES AND GLYCEROL BASED SURFACTANTS AND METHODS FOR THEIR USE IN FLOCCULATION

(71) Applicant: CARBONET NANOTECHNOLOGIES INC., Vancouver (CA)

(72) Inventors: Niloofar ALIPOORMAZANDARANI, Vancouver (CA); Mitchell PERRY, Vancouver (CA); Michael CARLSON, Vancouver (CA); Khatera HAZIN, Vancouver (CA); Jessica MARTIN, Vancouver (CA)

(21) Appl. No.: 19/122,430

(22) PCT Filed: Oct. 20, 2023
(86) PCT No.: PCT/CA2023/051402

§ 371 Date: Apr. 18, 2025

Related U.S. Application Data
(60) Provisional application No. 63/417,989, filed on Oct. 20, 2022.

(51) Int. Cl. B01D 21/01; C08L 33/26

(52) U.S. Cl. CPC B01D 21/01; C08L 33/26; B01D 2257/93; C08L 2205/14

(57) ABSTRACT

Provided are compositions comprising a cationic block co-polymer and a cationic polyacrylamide where the cationic polyacrylamide has a charge density in a range of from 2% to 100% In some embodiments, the cationic block co-polymer is part of a cationic polymer surfactant aggregate. The compositions may be used for removing solids from a solid liquid mixture. The methods may comprise: adding a composition to the solid-liquid mixture, b) agitating the solid liquid mixture together with the composition, and c) removing solids from the agitated mixture. The methods may comprise: a) mixing a cationic polyacrylamide polymer with a cationic polymer surfactant aggregate, thereby forming a conditioned flocculant; b) agitating the conditioned flocculant with the solid-liquid mixture, thereby forming an agitated mixture; and c) removing solids from the agitated mixture.

### CLAIM TO PRIORITY

This application is a National Stage entry of Application PCT/CA2023/051402, filed Oct. 20, 2023, and claims priority to U.S. Provisional Application No. 63/417,989 filed Oct. 20, 2022.

### TECHNICAL FIELD

This invention relates to the field of polymer and surfactant chemistry and in particular to the use of polymers and surfactants to enhance flocculation.

### BACKGROUND

Polyacrylamide based flocculants are commonly utilized for the aggregation of suspended solids in water treatment applications. The mechanism of action for these molecules is to “bridge” small particles in solution, facilitating their aggregation into larger particles. The formation of larger particles improves solid-liquid separation in conventional settling methods such as separation, floatation, and filtration. The method of polyacrylamide attachment to particles can be due to electrostatic interactions, Van der waals interactions, or hydrogen bonding.

### SUMMARY

In illustrative embodiments of the present invention, there is provided a composition comprising a) a cationic block co-polymer; and b) a cationic polyacrylamide, the cationic polyacrylamide having a charge density in a range of from 2% to 100%.

In illustrative embodiments of the present invention, there is provided a composition comprising a) SMA_{Quat}; and b) a cationic polyacrylamide, the cationic polyacrylamide having a charge density in a range of from 2% to 100%.

In illustrative embodiments of the present invention, there is provided a composition comprising a) a cationic polymer surfactant aggregate comprising a cationic block co-polymer and at least one of: i) a non-ionic surfactant; ii) a cationic surfactant and iii) a zwitterionic surfactant; and b) a cationic polyacrylamide, the cationic polyacrylamide having a charge density in a range of from 2% to 100%.

In illustrative embodiments of the present invention, there is provided a composition comprising a) a cationic polymer surfactant aggregate comprising SMA_{Quat} and at least one of: i) a non-ionic surfactant; ii) a cationic surfactant; and iii) a zwitterionic surfactant; and b) a cationic polyacrylamide, the cationic polyacrylamide having a charge density in a range of from 2% to 100%.

In illustrative embodiments of the present invention, there is provided a composition described herein wherein the cationic block co-polymer is part of a cationic polymer surfactant aggregate and the polymer surfactant aggregate further comprises a stabilizing surfactant and a size modifying surfactant.

In illustrative embodiments of the present invention, there is provided a composition described herein wherein the stabilizing surfactant, and the size modifying surfactant are each independently selected from at least one of: i) a non-ionic surfactant; ii) a cationic surfactant; and iii) a zwitterionic surfactant.

In illustrative embodiments of the present invention, there is provided a composition comprising a cationic polymer surfactant aggregate and a cationic polyacrylamide, the cationic polyacrylamide having a charge density in a range of from 2% to 100%.

In illustrative embodiments of the present invention, there is provided a composition described herein wherein the cationic polymer surfactant aggregate comprises a cationic block co-polymer, a stabilizing surfactant, and a size modifying surfactant.

In illustrative embodiments of the present invention, there is provided a composition described herein wherein the cationic block co-polymer is selected from the group consisting of: styrene carbamate block co-polymers, limonene carbamate block co-polymers, limonene maleimide block co-polymers, and styrene maleimide block co-polymers, and combinations thereof.

In illustrative embodiments of the present invention, there is provided a composition described herein wherein the stabilizing surfactant comprises at least one of an ethoxylated amine, a quaternary ammonium salt, Tween™ 20 (polyoxyethylene (20) sorbitan monolaurate), or 2-[4-(2,4,4-trimethylpentan-2-yl)phenoxy]ethanol (C₁₄H₂₂O(C₂H₄O)ₙ having the chemical formula:

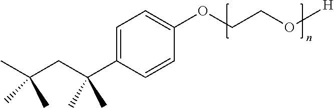

wherein n=4-5, 9, 10, or 30, or mixtures thereof.

In illustrative embodiments of the present invention, there is provided a composition described herein wherein the stabilizing surfactant comprises at least one of an ethoxylated amine, a quaternary ammonium salt, Tween™ 20 (polyoxyethylene (20) sorbitan monolaurate), Tween™ 40 (polyoxyethylene (20) sorbitan monopalmitate), Tween™ 60 (polyoxyethylene (20) sorbitan monostearate), Tween™ 80 (polyoxyethylene (20) sorbitan monooleate), Tergitol™ 15-S-20, Tergitol™ 15-S-40, or 2-[4-(2,4,4-trimethylpentan-2-yl)phenoxy]ethanol (C₁₄H₂₂O(C₂H₄O)ₙ having the chemical formula:

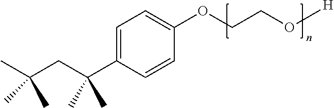

wherein n=4-5, n=9, n=10, n=30, or mixtures thereof.

In illustrative embodiments of the present invention, there is provided a composition described herein wherein the stabilizing surfactant comprises at least one of Tween™ 40 (polyoxyethylene (20) sorbitan monopalmitate), Tween™ 60 (polyoxyethylene (20) sorbitan monostearate), Tween™ 80 (polyoxyethylene (20) sorbitan monooleate), Tergitol™ 15-S-20, Tergitol™ 15-S-40, or mixtures thereof.

In illustrative embodiments of the present invention, there is provided a composition described herein wherein the size modifying surfactant is at least one selected from the group consisting of: an alkyl polyglucoside, lipid, oil, polyglycerol 3-caprylate, nonionic surfactants, sugar-derived surfactants, glycidyl-derived surfactants, fatty acid alcohol-derived surfactants, nonionic surfactants, saccharide polyethyleneoxide combination surfactants, saccharide ester surfactants, sulfonated sugar based surfactants, aldonamide based surfactants, amide sugar based surfactants, amino alcohol surfactants, amino acid based surfactants, polyol surfactants, 1,2 glycol surfactants, zwitterionic surfactants, and mixtures thereof.

In illustrative embodiments of the present invention, there is provided a composition described herein wherein the cationic polyacrylamide polymer has a charge density of from 10% to 100%.

In illustrative embodiments of the present invention, there is provided a composition described herein wherein the cationic polyacrylamide polymer has a charge density of 2%-19%, 20-40%, 60-79%, 80-100%, and combinations thereof.

In illustrative embodiments of the present invention, there is provided a composition described herein wherein the charge density range is 30%.

In illustrative embodiments of the present invention, there is provided a composition described herein wherein the cationic polyacrylamide polymer has a charge density of 40%.

In illustrative embodiments of the present invention, there is provided a composition described herein wherein the charge density range is 50%.

In illustrative embodiments of the present invention, there is provided a composition described herein wherein the cationic polyacrylamide polymer has a charge density of 80%.

In illustrative embodiments of the present invention, there is provided a composition described herein wherein the charge density range is 90%.

In illustrative embodiments of the present invention, there is provided a composition described herein wherein the cationic block co-polymer has a molecular weight of at least 5,000 Da.

In illustrative embodiments of the present invention, there is provided a composition described herein wherein the cationic block co-polymer has a molecular weight of at least 7,000 Da.

In illustrative embodiments of the present invention, there is provided a composition described herein wherein the cationic block co-polymer has a molecular weight of at least 27,000 Da.

In illustrative embodiments of the present invention, there is provided a composition described herein wherein the cationic block co-polymer has a molecular weight of at least 100,000 Da.

In illustrative embodiments of the present invention, there is provided a composition described herein wherein the cationic block co-polymer comprises a ratio of hydrophobic:hydrophilic groups of about 3:1.

In illustrative embodiments of the present invention, there is provided a composition described herein wherein the cationic block co-polymer comprises a ratio of hydrophobic:hydrophilic groups of about 2:1.

In illustrative embodiments of the present invention, there is provided a composition described herein wherein the cationic block co-polymer comprises a ratio of hydrophobic:hydrophilic groups of about 1:1.

In illustrative embodiments of the present invention, there is provided a composition described herein wherein the cationic block co-polymer is an amphipathic polymer.

In illustrative embodiments of the present invention, there is provided a composition described herein wherein the cationic polyacrylamide has a molecular weight in a range of from (2)10⁶ Da to (12)10⁶ Da.

In illustrative embodiments of the present invention, there is provided a composition described herein wherein the cationic polyacrylamide has a molecular weight in a range of from (5)10⁶ Da to (12)10⁶ Da.

In illustrative embodiments of the present invention, there is provided a composition described herein wherein the cationic polyacrylamide has a molecular weight in a range of from (5)10⁶ Da to (8)10⁶ Da.

In illustrative embodiments of the present invention, there is provided a composition described herein wherein the cationic polyacrylamide polymer has a charge density of 2-19%, 20-40%, 60-79%, 80-100%, and combinations thereof.

In illustrative embodiments of the present invention, there is provided a composition described herein wherein the cationic polyacrylamide polymer is selected from the group consisting of CPAM 835, CPAM 853, CPAM 611, CPAM 911, CPAM 911H, and combinations thereof.

In illustrative embodiments of the present invention, there is provided a composition described herein wherein the cationic polyacrylamide polymer is selected from the group consisting of CPAM 835, CPAM 853, CPAM 611, CPAM 911, CPAM 911H, CPAM 4808SSH, and combinations thereof.

In illustrative embodiments of the present invention, there is provided a composition described herein wherein the cationic polyacrylamide polymer is selected from the group consisting of CPAM 835, CPAM 853, CPAM 911, CPAM 911H, CPAM 4808SSH, and combinations thereof.

In illustrative embodiments of the present invention, there is provided a composition described herein wherein the cationic polyacrylamide polymer is selected from the group consisting of CPAM 835, CPAM 853, CPAM 911, CPAM 911H, and combinations thereof.

In illustrative embodiments of the present invention, there is provided a composition described herein wherein the cationic polyacrylamide polymer is CPAM 4808SSH.

In illustrative embodiments of the present invention, there is provided a method for removing solids from a solid-liquid mixture, the method comprising: a) mixing a cationic polyacrylamide polymer with a cationic polymer surfactant aggregate, thereby forming a conditioned flocculant; b) agitating the conditioned flocculant with the solid-liquid mixture, thereby forming an agitated mixture; and c) removing solids from the agitated mixture.

In illustrative embodiments of the present invention, there is provided a method described herein further comprising mixing a stabilizing surfactant with the cationic polymer surfactant aggregate.

In illustrative embodiments of the present invention, there is provided a method described herein wherein mixing the stabilizing surfactant with the cationic polymer surfactant aggregate occurs prior to mixing the cationic polyacrylamide polymer with the cationic polymer surfactant aggregate.

In illustrative embodiments of the present invention, there is provided a method described herein wherein mixing the stabilizing surfactant with the cationic polymer surfactant aggregate and mixing the cationic polyacrylamide polymer with the cationic polymer surfactant aggregate occur concurrently.

In illustrative embodiments of the present invention, there is provided a method described herein further comprising mixing a size modifying surfactant with the cationic polymer surfactant aggregate.

In illustrative embodiments of the present invention, there is provided a method for removing solids from a solid-liquid mixture, the method comprising: a) adding a composition described herein to the solid-liquid mixture; b) agitating the solid liquid mixture together with the composition, thereby forming an agitated mixture; and c) removing solids from the agitated mixture.

In illustrative embodiments of the present invention, there is provided a method described herein wherein the removing solids comprises at least one selected from the group consisting of: filtration, centrifugation, gravity separation, flotation, skimming, and electromagnetic attraction.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 illustrates particle aggregate diameter growth of [SMA_{Quat} 725]:[TX305][5]:[2.5]% with various polyglycerol caprylate surfactants at different concentrations. FIG. 1 A: Particle size distribution of [SMA_{Quat} 725]:[TX305]:[PG3-C][5]:[2.5]:[0-5]% solution. FIG. 1 B: Particle size distribution of [SMA_{Quat} 725]:[TX305]:[PG6-C][5]:[2.5]:[0-5]% solution. FIG. 1C: Particle size distribution of [SMA_{Quat} 725]:[TX305]:[PG10-C][5]:[2.5]:[0-5]% solution. All solutions were diluted to 0.1 wt. % prior to particle size measurements. [0% PG-C](very light grey); [1% PG-C](light grey); [2% PG-C](grey); [3% PG-C](dark grey); [5% PG-C](black).

FIG. 2 illustrates turbidity of 0.3% kaolin coagulated by [SMA_{Quat} 725]:[TX305][5]:[2.5]% and various concentrations of PG3-C surfactant: [0% PG3-C](black); [1% PG3-C](dark grey); [2% PG3-C](grey); [3% PG-C](light grey); [5% PG3-C](very light grey).

FIG. 3 illustrates the improvement of flocculation activity of a medium charge cationic polyacrylamide on a 0.3% Kaolin suspension by addition of NanoNet™. Praestol™ 835BS (CPAM 835) was prepared at 2% wt. stock and desired amount of NanoNet™ containing [SMA_{Quat} 725]:[TX305]:[PG3-C][5]:[2.5]:[2]% (NN_{A}) was added to form the final flocculant formulation CPAM 835:NN_{A}. CPAM 835 is a medium charge density and high molecular weight cationic polyacrylamide (solid line, black circle); CPAM 835:NN_{A} ratio of 1:0.25 (dashed line, light grey triangle).

FIG. 4 illustrates the effect of NanoNet™ addition on the rheological properties of a polyacrylamide solution. CPAM Hyperdrill™ CP911H (CPAM 911H) was prepared at 2% wt. stock and desired amount of NanoNet™ containing [SMA_{Quat} 725]:[TX305]:[PG3-C][5]:[2.5]:[2]% was added to create a mixed solution of NanoNet™ and polyacrylamide (CPAM911H:NN_{A}). CPAM 911H:NN_{A} (1:0.2 weight ratio) (solid line, black circle); CPAM:NN_{A} (1:0.3 ratio) (dashed line, light grey triangle); CPAM:NN_{A} (1:0.4 ratio) (dashed line, grey square); CPAM 911H:NN_{A} (1:0.6 ratio) (dashed line, dark grey triangle); CPAM 911H:NN_{A} (1:1 ratio) (dashed line, light grey circle).

FIG. 5 illustrates floc stability of CPAM:NN_{A} with shear over time at constant [CPAM] of 18 ppm in diluted mature fine tailings water matrix A. FIG. 5A) CPAM 835 is a medium charge density and high molecular weight cationic polyacrylamide. FIG. 5B) Praestol™ 853BC (CPAM 853) is a very high charge density and high molecular weight cationic polyacrylamide. FIG. 5C) Praestol™ 859BS (CPAM 859) is an extremely high charge density and high molecular weight cationic polyacrylamide. CPAM is prepared at 2% wt. stock and desired amount of NanoNet™ containing [SMA_{Quat} 725]:[TX305]:[PG3-C][5]:[2.5]:[2]% is added. Shearing conducted at 200 rpm. CPAM alone (solid line, black circle); CPAM:NN (1:0.25 wt/wt polyacrylamide:SMA_{Quat} 725; dashed line, light grey triangle); CPAM:NN (1:0.6 wt/wt polyacrylamide:SMA_{Quat} 725; dashed line, grey square); CPAM:NN (1:1 wt/wt polyacrylamide:SMA_{Quat} 725; dashed line, dark grey triangle).

FIG. 6 illustrates the effect of polyacrylamide concentration on flocculation efficacy of NanoNet™ and polyacrylamide blends in dilute mature fine tailings (Water Matrix A). A): CPAM Hyperdrill™ CP911 was prepared at 3% wt/vol before addition of varying amounts of NanoNet™ A ([SMA_{Quat} 725]:[TX305]:[PG3-C]5:2.5:2%) to make several flocculant formulations (CPAM911H:NN_{A}). The flocculation activity of the CPAM alone (solid line, black circle); CPAM911H:NN_{A} (1:0.25 wt/wt CPAM911H:SMA_{Quat} 725; dashed line, light grey triangle); CPAM911H:NN_{A} (1:0.4 wt/wt CPAM911H:SMA_{Quat} 725 dashed line, grey square); CPAM911H:NN_{A} (1:1 wt/wt CPAM911H:SMA_{Quat} 725; dashed line, dark grey triangle) were measured in dilute mature fine tailings. 6B): Same as in 6A, with CPAM Hyperdrill™ CP911 prepared at 5% before addition of NanoNet™ A; FIG. 6C): Same as in 6A, with CPAM Hyperdrill™ CP911 was prepared at 6% before addition of NanoNet™ A.

FIG. 7 illustrates the effect of NanoNet™ on flocculation efficacy of high charge cationic polyacrylamide (CPAM Hyperdrill™ CP911H) on an oily sludge water Matrix D (1:1 dilution in distilled water). FIG. 7A): CPAM911H dosage required for full flocculation with and without NN_{A} (CPAM 911H alone (black); CPAM911H:NN_{A} (grey)). FIG. 7B) turbidity of filtrate after dewatering of flocculated Matrix D. Turbidity of filtrate was measured at 269 ppm for CPAM911H and 141 ppm for CPAM911H:NN_{A} (1:0.25 wt/wt CPAM911H:SMA_{Quat} 725) which were found to provide equivalent settling rates in 7A.

FIG. 8 illustrates the effect of NanoNet™ on CPAM 911H upon flocculation of concentrated mature fine tailings water matrix C. CPAM 911H was prepared at 3% and desired amount of NanoNet™ A was added. FIG. 8A) optimum dosage to achieve full flocculation CPAM (black); CPAM911H:NN_{A} (1:0.25 wt/wt CPAM911H:SMA_{Quat} 725; dark grey), CPAM911H:NN_{A} (1:0.4 wt/wt CPAM911H:SMA_{Quat} 725; grey); CPAM911H:NN_{A} (1:0.6 wt/wt CPAM911H:SMA_{Quat} 725; light grey). FIG. 8B) Drainage rate of flocs over total volume in 60 seconds; CPAM (solid line, black circle); CPAM911H:NN_{A} (1:0.25 wt/wt CPAM911H:SMA_{Quat} 725; dashed line, light grey triangle); CPAM911H:NN_{A} (1:0.4 wt/wt CPAM911H:SMA_{Quat} 725; dashed line, grey square); CPAM911H:NN_{A} (1:0.6 wt/wt CPAM911H:SMA_{Quat} 725; dashed line, dark grey triangle).

FIG. 9 illustrates the stability analysis of CPAM Hyperdrill™ CP911 and CPAM911H:NN_{A} in 0.3% kaolin. CPAM Hyperdrill™ CP911 was prepared at 5% CPAM and desired amount of NanoNet™ containing [SMA_{Quat} 725]:[TX305]:[PG3-C][5]:[2.5]:[2]% was added to reach a final wt/wt ratio of 1:0.25 CPAM911H:SMA_{Quat} 725. FIG. 9A) Efficacy of samples in flocculating 0.3% kaolin over time compared to the fresh sample at 0 days; FIG. 9B) Viscosity changes over time at 30 rpm. CPAM (black); CPAM911H:NN_{A} (grey).

FIG. 10 illustrates particle size growth of [SMA_{Quat} 725]:[Tween™ 20][5]:[2]% system with various [APG] ratios. [1% APG](very light grey); [2% APG](light grey); [2% APG](grey); [2.5% APG](dark grey); [3% PG3-C](black).

FIG. 11 illustrates relative settling rate of CPAM853 alone or conditioned with NanoNet™ B (SMA_{Quat} 725:Tween™ 20:APG 5:2:2.5 wt/vol %). The relative settling rates for CPAM835 whether dosed alone (solid line, black circle) or after NanoNet™ conditioning (1:0.5 CPAM835:SMA_{Quat} 725 wt ratio; dashed line, light grey triangle) are reported.

FIG. 12: illustrates CPAM911H requirements for full flocculation of water matrix D when dosed alone or when conditioned with two different ratios of NanoNet™_{B} in diluted water matrix D (50% in distilled water). CPAM (black); CPAM911H:NN_{B} (1:0.25 CPAM911H:SMA_{Quat} 725 wt ratio; grey); CPAM911H:NN_{B} (1:0.5 CPAM911H:SMA_{Quat} 725 wt ratio; light grey).

FIG. 13: illustrates FTIR spectrum of SMA-1 and quaternized SMA-1 (SMA_{Quat} 725).

FIG. 14: illustrates an ¹H NMR spectra of SMA-1 and SMA_{Quat} 725. Analysis performed in DMSO-d₆, 400 MHz. Star indicates residual solvent.

FIG. 15: illustrates an ¹³C NMR spectra of SMA-1 and SMA_{Quat} 725. Analysis performed in DMSO-d₆, 400 MHz. Star indicates solvent. Residual DMF observed at 35.7 and 30.7 ppm.

FIG. 16: illustrates a FTIR spectra of [SMA_{Quat} 725]I FIG. 17: illustrates an ¹H NMR spectra of SMA_{Quat} 725 I. Analysis performed in DMSO-d₆.

FIG. 18: illustrates a ¹³C NMR spectra of SMA_{Quat} 725 I. Analysis performed in DMSO-d₆.

FIG. 19: illustrates a FTIR spectrum of SMA_{Quat} 725 Cl.

FIG. 20: illustrates an ¹H NMR spectra of SMA_{Quat} 725 Cl. Analysis performed in DMSO-d₆.

FIG. 21: illustrates a ¹³C NMR spectra of SMA_{Quat} 725 Cl. Analysis performed in DMSO-d₆.

FIG. 22: illustrates a FTIR spectrum of cumene terminated SMA-1.

FIG. 23: illustrates a FTIR spectrum of cumene terminated SMA_{Quat}.

FIG. 24: illustrates the effect of NN_{A} containing cationic polymer with two different end groups (SMA_{Quat} 725 non-cumene terminated and SMA_{Quat} 725 cumene terminated, respectively) on the flocculation efficacy of a cationic polyacrylamide solution. CPAM 4808SSH was prepared at 3% wt/vol stock and desired amount of NanoNet™ containing [SMA_{Quat} 725 cumene terminated or non-cumene terminated]:[TX305]:[PG3-C][5]:[2.5]:[2]% (NN_{A}) was added at the ratio of CPAM:NN_{A} 1:0.25 to create a mixed solution of NanoNet™ and cationic polyacrylamide (CPAM:NN_{A}). CPAM (3% wt/vol, control) (solid line, black circle); CPAM:NN_{A} (1:0.25 wt/wt ratio polyacrylamide: SMA_{Quat} 725 non-cumene terminated) (dashed line, light grey triangle); CPAM:NN_{A} (1:0.25 wt/wt ratio polyacrylamide: SMA_{Quat} 725 cumene terminated) (dashed line, grey square).

FIG. 25: illustrates the effect of NanoNet™ addition containing different SMA_{Quat} polymers with different hydrophobic:hydrophilic ratios on the flocculation efficacy of cationic polyacrylamide solution. CPAM CP911H was prepared at 3% wt/vol stock and desired amount of NanoNet™ containing [SMA_{Quat}]:[TX305]:[PG3-C][5]:[2.5]:[2]% (NN_{A}) was added to create a mixed solution of NanoNet™ and cationic polyacrylamide (CPAM:NN_{A}). CPAM:NN_{A} (1:0.25 wt/wt ratio polyacrylamide:SMA_{Quat} 725) (solid line, black circle); CPAM:NN_{A} (1:0.25 wt/wt ratio polyacrylamide:NN_{A} containing SMA_{Quat} 130 with hydrophobic:hydrophilic ratio of 2:1) (dashed line, light grey triangle); CPAM:NN_{A} (1:0.25 wt/wt ratio polyacrylamide:NN_{A} containing SMA_{Quat} 150 with hydrophobic:hydrophilic ratio of 1:1) (dashed line, grey square); CPAM:NN_{A} (1:0.25 wt/wt ratio polyacrylamide:NN_{A} containing SMA_{Quat} 230 with hydrophobic:hydrophilic ratio of 2:1) (dashed line, dark grey triangle).

### DETAILED DESCRIPTION

As used herein, the following terms are generally used interchangeably unless the context makes clear otherwise: Bio-soft™ N1-7 (CAS #34398-01-1); BS7; alcohol ethoxylates; undecan-1-ol, ethoxylated; and poly(oxy-1, 2-ethanediyl), alpha-undecyl-omega-hydroxy.

As used herein, the following terms are generally used interchangeably unless the context makes clear otherwise: Bio-soft™ N1-9 (CAS #34398-01-1); alcohol ethoxylates; and linear alcohol (C₁₁) ethoxylate.

As used herein, the following terms are generally used interchangeably unless the context makes clear otherwise: Bio-soft™ N25-9 (CAS #68131-39-5); and alcohols, C₁₂₋₁₅, ethoxylated.

As used herein, the following terms are generally used interchangeably unless the context makes clear otherwise: Bio-soft™ N91-8 (CAS #68439-46-3); BS N91-8; BS8; and alcohols C9-11, ethoxylated.

As used herein, the following terms are generally used interchangeably unless the context makes clear otherwise: Bio-soft™ surfactants; and linear alcohol ethoxylates.

As used herein, the following terms are generally used interchangeably unless the context makes clear otherwise: Brij™ 35 (CAS #9002-92-0); 2-(dodecyloxy)ethan-1-ol; polymer of ethylene glycol and 1-dodecyl alcohol with >20 mol ethylene oxide; polyoxyethyleneglycol dodecyl ether; and Polyoxyethylene (23) Lauryl Ether.

As used herein, the following terms are generally used interchangeably unless the context makes clear otherwise: Brij™ 010 (CAS #9004-98-2); Polyoxyethylene (10) oleyl ether; Brij™ 97; 2-[(9Z)-9-Octadecen-1-yloxy]ethanol.

As used herein, the following terms are generally used interchangeably unless the context makes clear otherwise: Brij™ surfactants; alcohol ethoxylates; alcohols, ethoxylated fatty alcohols; laureth compounds; and ethoxylated natural fatty alcohol, polyethylene oxide ether.

As used herein, the following terms are generally used interchangeably unless the context makes clear otherwise: CPAM Hyperdrill™ 911; and CPAM 911; cationic polyacrylamide with 80% charge density and medium molecular weight.

As used herein, the following terms are generally used interchangeably unless the context makes clear otherwise: CPAM Hyperdrill™ 911H; and CPAM 911H; cationic polyacrylamide with 80% charge density and medium molecular weight.

As used herein, the following terms are generally used interchangeably unless the context makes clear otherwise: CPAM Praestol™ 835 BS (CAS #372543); and CPAM 835; cationic polyacrylamide with medium charge density and high molecular weight.

As used herein, the following terms are generally used interchangeably unless the context makes clear otherwise: CPAM Praestol™ 853 BC (CAS #790265); and CPAM 853; cationic polyacrylamide with very high charge density and high molecular weight.

As used herein, the following terms are generally used interchangeably unless the context makes clear otherwise: CPAM Praestol™ 859 BS (CAS #380868); and CPAM 859; cationic polyacrylamide with extremely high charge density and high molecular weight.

As used herein, the following terms are generally used interchangeably unless the context makes clear otherwise: Eco Brij™ Lauryl-Olyl-Stearyl-Cetyl-Cetearyl based series; and ethoxylated fatty alcohols.

As used herein, the following terms are generally used interchangeably unless the context makes clear otherwise: Eco Tween™ series surfactants; Tween™ series surfactants; and polysorbates.

As used herein, the following terms are generally used interchangeably unless the context makes clear otherwise: Eco Tween™ 20 (CAS #9005-64-5); Tween™ 20; ethoxylated (20) sorbitan ester based on a natural fatty acid (lauric acid); polyoxyethylene (20) sorbitan monolaurate; polyethylene glycol sorbitan monolaurate; polyoxyethylenesorbitan monolaurate; polyethylene glycol sorbitan monolaurate; and polysorbate 20.

As used herein, the following terms are generally used interchangeably unless the context makes clear otherwise: Eco Tween™ 40 (CAS #9005-66-7); Tween™ 40; polyoxyethylene (20) sorbitan monopalmitate; polyoxyethylenesorbitan monopalmitate; and polysorbate 40.

As used herein, the following terms are generally used interchangeably unless the context makes clear otherwise: Eco Tween™ 60 (CAS #9005-67-8); Tween™ 60; polyoxyethylene (20) sorbitan monostearate; polyethylene glycol sorbitan monostearate; polyoxyethylene sorbitan monostearate; and polysorbate 60.

As used herein, the following terms are generally used interchangeably unless the context makes clear otherwise: Eco Tween™ 80 (CAS #9005-65-6); Tween™ 80; ethoxylated sorbitan ester based on a natural fatty acid (palmitic acid); polyoxyethylene (20) sorbitan monooleate; polyethylene glycol sorbitan monooleate; polyoxyethylenesorbitan monooleate, and polysorbate 80.

As used herein, the following terms are generally used interchangeably unless the context makes clear otherwise: Eco Tween™ 85 (CAS #9005-70-3); Tween™ 85; polyoxyethylenesorbitan trioleate; and polysorbate 85.

As used herein, the following terms are generally used interchangeably unless the context makes clear otherwise: FLOPAM™ FO 4808SSH; and CPAM 4808SSH.

As used herein, the following terms are generally used interchangeably unless the context makes clear otherwise: Genapol™ X80 (CAS #9043-30-5); GP80; polyethylene glycol monoalkyl ether; oligoethylene glycol monoalkyl ether; and iso-tridecyl alchohol polyglycol ether (8EO).

As used herein, the following terms are generally used interchangeably unless the context makes clear otherwise: Myrj™ 52 (CAS #9004-99-3); 2-hydroxyethyl octadecenoate; 2-hydroxyethyl stearate; glycol stearate; 2-hydroxyethyl octadecenoate; and polyoxyethylene(40) stearate.

As used herein, the following terms are generally used interchangeably unless the context makes clear otherwise: Myrj™ surfactant series; non-ionic, ethoxylated fatty acid, polyoxyethylene stearate.

As used herein, the following terms are generally used interchangeably unless the context makes clear otherwise: Praestol™ 611 BC; and CPAM 611.

As used herein, the following terms are generally used interchangeably unless the context makes clear otherwise: sucrose ester S-1670 stearic fatty acid (CAS #25168-73-4); [(2S,3S,4S,5R)-3,4-dihydroxy-5-(hydroxymethyl)-2-[(2R,3R,4S,5S,6R)-3,4,5-trihydroxy-6-(hydroxymethyl)oxan-2-yl]oxyoxolan-2-yl]methyloctadecanoate; α-D-glucopyranoside β-D-fructofuranosyl monooctadecanoate; sucrose monostearate; and stearic acid monoester with sucrose.

As used herein, the following terms are generally used interchangeably unless the context makes clear otherwise: Tergitol™ 15-S-20 (CAS #84133-50-6); TG 15-S-20; secondary alcohol ethoxylates; and alcohols, C₁₂₋₁₄-secondary, ethoxylated.

As used herein, the following terms are generally used interchangeably unless the context makes clear otherwise: Tergitol™ 15-S-40 (CAS #84133-50-6); TG 15-S-40; secondary alcohol ethoxylate 41EO, and alcohols C₁₂₋₁₄-secondary ethoxylated.

As used herein, the following terms are generally used interchangeably unless the context makes clear otherwise: Tergitol™ 15-S-9 (CAS #84133-50-6); secondary alcohol ethoxylate; sec-alcoxy polyethylene glycol, repeating unit=9, molecular weight of 607 g/mol.

As used herein, the following terms are generally used interchangeably unless the context makes clear otherwise: Tergitol™ NP-10 (CAS #127087-87-0); 2-{2-[2-(4-nonylphenoxy)ethoxy]ethoxy}ethan-1-ol; nonylphenol ethoxylate; alkylphenol ethoxylate (APE); mono(p-nonylphenyl)ether; and polyethylene glycol mono(branched p-nonylphenyl) ether; molecular weight of 682 g/mol

As used herein, the following terms are generally used interchangeably unless the context makes clear otherwise: Tergitol™ NP-9 (CAS #127087-87-0); mono(p-nonylphenyl)ether; nonoxynol-9; polyethylene glycol mono(branched p-nonylphenyl) ether; molecular weight of 616 g/mol.

As used herein, the following terms are generally used interchangeably unless the context makes clear otherwise: Tergitol™ surfactants; alcohol ethoxylates; non-ionic surfactant, and secondary alcohol ethoxylate.

As used herein, the following terms are generally used interchangeably unless the context makes clear otherwise: Triton™ series surfactants; 2-[4-(2,4,4-trimethylpentan-2-yl)phenoxy]ethanol (C₁₄H₂₂O(C₂H₄O)ₙ with n=30, n=9, n=10, and/or n=4-5; and poly(ethylene glycol).

As used herein, the following terms are generally used interchangeably unless the context makes clear otherwise: Triton™ CG-110 (CAS #68515-73-1); and alkyl polyglucoside (APG).

As used herein, the following terms are generally used interchangeably unless the context makes clear otherwise: Triton™ X-305 (CAS #9002-93-1); TX305; polyethylene glycol mono(4-tert-octylphenyl) ether; polyethylene glycol p-octylphenol ether; and 2-[4-(2,4,4-trimethylpentan-2-yl)phenoxy]ethanol (C₁₄H₂₂O(C₂H₄O)ₙ with n=30.

As used herein the term “SMA_{Quat}” refers to a cationic block co-polymer formed from styrene maleimide units. Examples of the cationic block co-polymer include, but are not limited to, styrene carbamate block co-polymers, limonene carbamate block co-polymers, limonene maleimide block co-polymers, and combinations thereof.

As used herein, the term “polymer surfactant aggregate” refers to a particle that is a formed by an association between a polymer and surfactant aggregate. The polymer surfactant aggregate self-assembles in an aqueous environment, is stable in aqueous solution, and is comprised of i) a polymer and ii) a surfactant aggregate. Polymer surfactant aggregates remain associated at lower concentrations relative to surfactant aggregates in the absence of the polymer. The solution stability of polymer surfactant aggregates may be disrupted by the addition of a suitable destabilization material. Often, polymer surfactant aggregates are colloidal particles comprising amphipathic block co-polymers and surfactants and optionally a modifying surfactant and/or a size modifying surfactant. The amphipathic block co-polymers often comprise a hydrophilic functional group and a hydrophobic functional group. Examples of the hydrophilic functional group include, but are not limited to, and an amide or imide linked ethanol group, an amide or imide linked primary, secondary, tertiary, or quaternary amine, an amide or imide linked thiol group. The polymer can also contain amide or imide linked zwitterionic groups such as carboxylated quaternary amines. Examples of the hydrophobic functional group include, but are not limited to, a straight or branched alkyl chain, saturated, mono-unsaturated or poly-unsaturated, aliphatic cyclic, polycyclic, aromatic cyclic having at least one aromatic ring, a styrene, di-isobutyl, saturated and unsaturated alkyl chains, limonene, and pinene. In some embodiments, the aromatic cyclic is alkylated. Generally, the hydrophobic monomeric unit has as few as 3 and as many as 12 carbon atoms. Some examples of polymer surfactant aggregates are described in PCT International Patent Application publication number WO2020/113330, published Jun. 11, 2020. As used herein, the term “cationic polymer surfactant aggregate” refers to a polymer surfactant aggregate that has an overall positive charge where the surfactants and polymer interact through association of their hydrophobic functional groups. Often a cationic polymer surfactant aggregate is formed from a cationic block co-polymer (such as poly(styrene-co-maleimide with pendant amine groups and derivatives thereof), a stabilizing surfactant (such as Triton™ series surfactants like Triton™ X-305 or Tween™ series surfactants like Tween™ 20), and a size modifying surfactant (such as polyglycerol 3-caprylate or decyl glucoside). Often, NanoNet™ compositions are polymer surfactant aggregates. In some embodiments, the polymer surfactant aggregates suitable for use in the present invention are non-ionic. In other embodiments, the polymer surfactant aggregates suitable for use in the present invention are ionic, but must not carry an overall anionic charge.

As used herein, the term “stabilizing surfactant” refers to a surfactant with hydrophobic lipid balance (HLB) >14, and often carries no charge in its hydrophilic headgroup. In some preferred embodiments, the surfactant consists of a hydrophilic headgroup of repeating ethoxylate, sorbate, or other non-ionic water soluble groups. In some other preferred embodiments, the stabilizing surfactant may carry a cationic hydrophilic head group. The hydrophobic portion of the surfactant can consist of saturated or unsaturated alkyl chains or aromatic groups. Non-limiting examples of stabilizing surfactants suitable for use in the present invention include, but are not limited to, an ethoxylated amine, an ethoxylated sorbitan ester fatty acid, a quaternary ammonium salt, Tween™ 20 (polyoxyethylene (20) sorbitan monolaurate), Tween™ 40 (polyoxyethylene (20) sorbitan monopalmitate), Tween™ 60 (polyoxyethylene (20) sorbitan monostearate), Tween™ 80 (polyoxyethylene (20) sorbitan monooleate), or 2-[4-(2,4,4-trimethylpentan-2-yl)phenoxy]ethanol (C₁₄H₂₂O(C₂H₄O)ₙ having the chemical formula:

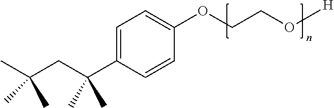

wherein n=4-5, n=9, n=10, or n=30, Eco Tween™ series (Eco Tween™ 20 & Eco Tween™ 80) (100% biodegradable), Tergitol™ 15-S-40 (HLB 18), Brij™ 35 (HLB 16.9), Tergitol™ 15-S-20 (HLB 15), sucrose ester S-1670 stearic fatty acid (HLB 16), Myrj™ 52 (polyoxyethylene monostearate) (HLB 16.9), Eco Brij™ Lauryl-Olyl-Stearyl-Cetyl-Cetearyl based series (HLB 11-18.8 and in some cases acts as either or both a size modifying and a stabilizing surfactant depending on degree of ethoxylation and HLB), and/or mixtures thereof. In some embodiments, the stabilizing surfactants suitable for use in the present invention are non-ionic. In other embodiments, the stabilizing surfactants suitable for use in the present invention are ionic.

As used herein, the term “size modifying surfactant” refers to a surfactant with a hydrophobic lipid balance (HLB) between 10-14. The size modifying surfactant may be non-ionic or zwitterionic or cationic, but must not carry an overall anionic charge. Examples of size modifying surfactants suitable for use in the present invention include, but are not limited to Tergitol™ surfactants (non-ionic surfactant, secondary alcohol ethoxylate), Bio-soft™ (linear alcohol ethoxylate) surfactants, arginate-based surfactants, sucrose ester fatty acid, Brij™ surfactants (ethoxylated natural fatty alcohol, polyethylene oxide ether) and Myrj™ surfactant series (non-ionic, ethoxylated fatty acid, polyoxyethylene stearate) and re-fatting surfactants. Refatting agents are often polyglycerol-based and examples include, but are not limited to glycol distearate, glycerol oleate, glyceryl cocoate and/or combinations thereof. In some preferred embodiments the size modifying surfactant has a low HLB. Some non-limiting examples of low HLB size modifying surfactants include Bio-soft™ N1-9 (HLB=13.9), Bio-soft™ N25-9 (HLB=13.3), Tergitol™ NP-9 (HLB=12.9), Tergitol™ 15-S-9 (HLB=13.3), Tergitol™ NP-10 (HLB=13.3), BS7 (Bio-soft™ N1-7) (HLB=12.9), GP80 (Genapol™ X80) (HLB=12), BS8 (Bio-soft™ N91-8) (HLB=13.9), Ethyl lauroyl arginate HCl cationic (HLB=10.5), Brij™ 010 (HLB=12.4), Eco Brij™ Lauryl-Olyl-Stearyl-Cetyl-Cetearyl based series (HLB 11-18.8 and in some cases acts as either or both a size modifying and a stabilizing surfactant depending on degree of ethoxylation and HLB) and/or combinations thereof.

As used herein, the term “polyacrylamide” means a polymer formed from non-ionic acrylamide subunits and an additional monomer suitable for radical polymerization. The choice of additional monomers can be cationic in nature, such as [2-(acryloyloxy)ethyl]trimethyl-ammonium chloride (AETAC), dimethyldiallyammonium chloride (DADMAC), Methyl acrylacyl oxyethyl trimethyl ammonium chloride (DMC), 2-(methacryloyloxy)ethyl trimethylammonium chloride (MAETAC), Methyacrylamidopropyltrimethylammonium chloride (MAPTAC). A cationic polyacrylamide (CPAM) is a polyacrylamide having an overall positive charge. CPAMs may be categorized according to their charge density. Medium charge density CPAMs have a charge density in the range of: 20% to 40%. High charge density CPAMs have a charge density in the range of: 40% to 60%. Very high charge density CPAMs have a charge density in the range of: 60% to 79%. Extremely high charge density CPAMs have a charge density in the range of: 80% to 100%. Polyacrylamides may have a linear-chain structure or a cross-linked structure. Polyacrylamides suitable for use in the present invention include polyacrylamides that are cationic in nature, and the cationic monomer mole percentage incorporated into the final polymer is from 2% to 100%. Polyacrylamides that are not suitable for use in the present invention include polymers that are anionic in charge in aqueous solution. As used herein, the term “acrylamide subunit” refers to a moiety having a chemical formula of —CH₂CHCONH₂—.

As used herein the term “about” means that precise adherence to the exact numerical value following the term “about” is not absolutely required or essential and that some minor deviation from the exact value is permissible. In many circumstances a deviation of ±10% is acceptable. In preferred circumstances a deviation of ±5% is acceptable. In still other preferred circumstances, a deviation of ±1% is acceptable. In still other preferred circumstances, a deviation of ±0.1% is acceptable.

As used herein, the term “moiety” refers to the radical of a molecule that is attached to another moiety.

As used herein, the term “alkyl” by itself or as part of another substituent, means, unless otherwise stated, a straight or branched chain, or cyclic hydrocarbon radical, or combination thereof, which may be fully saturated, mono- or polyunsaturated and can include di- and multivalent radicals, having the number of carbon atoms designated (e.g. C₁-C₁₀ or 1- to 10-membered means one to ten carbons). Examples of saturated hydrocarbon radicals include, but are not limited to, groups such as methyl, ethyl, n-propyl, isopropyl, n-butyl, t-butyl, isobutyl, sec-butyl, cyclohexyl, (cyclohexyl)methyl, cyclopropylmethyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. The term “alkyl” is meant to include both substituted and unsubstituted forms of the indicated radical, unless otherwise clear from context. Preferred substituents are provided below.

As used herein, the term “charge density” refers to the molar percent of monomers which contain charged functional groups within the polymer. In some embodiments that can be related to a property of a moiety that can be described by the formula charge density=charge/volume. The charge density of polyacrylamides is described in Smith-Palmer, T; Wentzell, B. R, Definition of the charge density of acrylamide/acrylate copolymers by tensammetry. Can. J. Chem. 68, 26 (1990).

As used herein, the term “molecular weight” means the molecular mass of a given molecule measured in daltons (Da). The molecular weight is a weighted average and in particular the weight of macromolecules is referred to as their molecular weight and is often expressed in kDa, although the numerical value is often approximate and representative of an average weight per molecule. As is often the case with polymers, the composition of bulk polymer comprises individual polymers having different molecular weights and are often obtained and/or sold as an average molecular weight, meaning that some of the individual polymers within the bulk polymer may have above or below the average molecular weight and many of the individual polymers will have the average molecular weight. It is acceptable in embodiments of the present invention that bulk polymers having individual polymers with different molecular weights from each other are used. It is also acceptable in embodiments of the present invention that bulk polymers having only individual polymers with the same molecular weight as each other are used. A person of skill in the art of polymers will be familiar with this approach to average molecular weights of polymers and will readily be able to identify polymers, both bulk polymers and individual polymers that are suitable for use in compositions of the present invention based on this teaching.

As used herein, the term “solid-liquid mixture” refers to a mixture having suspended solid particles in it. Often solid-liquid mixtures are aqueous mixtures.

As used herein, the term “agitating” refers to mixing, stirring, or otherwise encouraging the components in a liquid or solid-liquid mixture to move and contact each other. A person of skill in the art will be familiar with a large variety of agitating techniques and such techniques may be used in embodiments of the present invention.

In illustrative embodiments there is provided a composition comprising a cationic polymer surfactant aggregate and a cationic polyacrylamide (CPAM). The CPAM has a charge density in a range of from 2% to 100%. In some preferred embodiments, the CPAM has a charge density in a range of from 10% to 100%. In some other preferred embodiments, the CPAM has a low charge density (i.e. in the range of 2% to 19%). In some other preferred embodiments, the CPAM has a medium charge density (i.e. in the range of: 20% to 40%). In some other preferred embodiments, the CPAM has a high charge density (i.e. in the range of: 40% to 60%). In some other preferred embodiments, the CPAM has a very high charge density (i.e. in the range of: 60% to 79%). In some other preferred embodiments, the CPAM has an extremely high charge density (i.e. in the range of: 80% to 100%). In some preferred embodiments, the polyacrylamide has a charge density of 30%. In some other preferred embodiments, the polyacrylamide has a charge density of 40%. In some other preferred embodiments, the polyacrylamide has a charge density of 50%. In some other preferred embodiments, the polyacrylamide has a charge density of 80%. In some other preferred embodiments, the CPAM has a charge density of 90%.

In some illustrative embodiments, the cationic polyacrylamide has a molecular weight in a range of from (2)10⁶ to (30)10⁶. In some preferred embodiments, the cationic polyacrylamide has a molecular weight in a range of from (5)10⁶ to (12)10⁶. In some other preferred embodiments, the cationic polyacrylamide has a molecular weight in a range of from (5)10⁶ to (8)10⁶. The poly(2-propenamide) or cationic polyacrylamide polymer “CPAM” is selected from the group consisting of CPAM Praestol™ 835BS (CPAM 835), Praestol™ 853BC (CPAM 853), Praestol™ 611 BC (CPAM 611), CPAM Hyperdrill™ 911 (CPAM 911), CPAM Hyperdrill™ 911H (CPAM 911H), and combinations thereof. In some other preferred embodiments, the cationic polyacrylamide polymer is selected from the group consisting of CPAM Praestol™ 835BS (CPAM 835), Praestol™ 853BC (CPAM 853), CPAM Hyperdrill™ 911 (CPAM 911), CPAM Hyperdrill™ 911H (CPAM 911H), and combinations thereof.

In some illustrative embodiments, the cationic polymer surfactant aggregate comprises a cationic block co-polymer, a stabilizing surfactant, and a size modifying surfactant. In some of these embodiments, it is preferred that the cationic block co-polymer is, styrene maleimide block co-polymers, or combinations thereof.

In some illustrative embodiments, the cationic block co-polymer has a molecular weight of at least 5,000 Da. In some other preferred embodiments, the cationic block co-polymer has a molecular weight of at least 7,000 Da. In some other preferred embodiments, the cationic block co-polymer has a molecular weight of at least 27,000 Da. In some other preferred embodiments, the cationic block co-polymer has a molecular weight of at least 100,000 Da. In some illustrative embodiments, the cationic block co-polymer comprises a ratio of hydrophobic:hydrophilic groups of about 3:1. In some other illustrative embodiments, the cationic block co-polymer comprises a ratio of hydrophobic:hydrophilic groups of about 2:1. In some preferred illustrative embodiments, the cationic block co-polymer comprises a ratio of hydrophobic:hydrophilic groups of about 1:1. In some preferred illustrative embodiments, the cationic block co-polymer is an amphipathic polymer.

In some illustrative embodiments, the stabilizing surfactant may be a Tween™ surfactant, an ethoxylated amine, an ethoxylated sorbitan ester fatty acid, a quaternary ammonium salt, Eco Tween™ series (Eco Tween™ 20 & Eco Tween™ 80) Tergitol™ 15-S-40 (HLB 18), Brij™ 35 (HLB 16.9), Tergitol™ 15-S-20 (HLB 15), Sucrose ester S-1670 stearic fatty acid (HLB 16), Myrj™ 52 (polyoxyethylene monostearate) (HLB 16.9), Eco Brij™ Lauryl-Olyl-Stearyl-Cetyl-Cetearyl based series (HLB 11-18.8 and in some cases acts as either or both a size modifying and a stabilizing surfactant depending on degree of ethoxylation and HLB), 2-[4-(2,4,4-trimethylpentan-2-yl)phenoxy]ethanol (C₁₄H₂₂O(C₂H₄O)ₙ having the chemical formula:

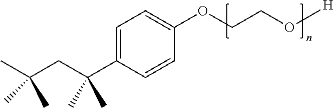

wherein n=4-5, n=9, n=10, and/or n=30, or any combination and/or mixture of an ethoxylated amine, a quaternary ammonium salt, and/or 2-[4-(2,4,4-trimethylpentan-2-yl)phenoxy]ethanol (C₁₄H₂₂O(C₂H₄O)ₙ having the chemical formula:

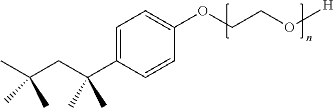

wherein n=4-5, n=9, n=10, and/or n=30. In some preferred embodiments, the stabilizing surfactant is Tween™ 20, which has the chemical formula as follows:

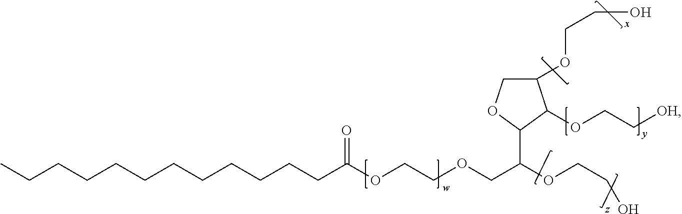

where w+x+y+z=20.

In some illustrative embodiments, the size modifying surfactant may be an alkyl polyglucoside, lipid, oil, polyglycerol 3-caprylatesurfactant, polyglycerol 6-caprylate surfactant, polyglycerol 10-caprylate surfactant, sugar-derived surfactant, glycidyl-derived surfactant, fatty acid alcohol-derived surfactant, nonionic surfactant, saccharide polyethyleneoxide combination surfactant, saccharide ester surfactant, sulfonated sugar based surfactant, aldonamide based surfactant, amide sugar based surfactant, amino alcohol surfactant, amino acid based surfactant, polyol surfactant, 1,2 glycol surfactant, zwitterionic surfactant, and/or any mixtures and/or combination thereof. In some other preferred embodiments, size modifying surfactants suitable for use in the present invention include, but are not limited to Tergitol™ surfactants (non-ionic surfactant, secondary alcohol ethoxylate), Bio-soft™ (linear alcohol ethoxylate) surfactants, arginate-based surfactants, sucrose ester fatty acid, Brij™ surfactants (ethoxylated natural fatty alcohol, polyethylene oxide ether) and Myrj™ surfactant series (non-ionic, ethoxylated fatty acid, polyoxyethylene stearate) and re-fatting surfactants. Refatting agents are often polyglycerol-based and examples include, but are not limited to glycol distearate, glycerol oleate, glyceryl cocoate and/or combinations thereof. In some preferred embodiments the size modifying surfactant has a low HLB. Some non-limiting examples of low HLB size modifying surfactants include Bio-soft™ N1-9 (HLB=13.9), Bio-soft™ N25-9 (HLB=13.3), Tergitol™ NP-9 (HLB=12.9), Tergitol™ 15-S-9 (HLB=13.3), Tergitol™ NP-10 (HLB=13.3), BS7 (Bio-soft™ N1-7) (HLB=12.9), GP80 (Genapol™ X80) (HLB=12), BS8 (Bio-soft™ N91-8) (HLB=13.9), Ethyl lauroyl arginate HCl cationic (HLB=10.5), Brij™ 010 (HLB=12.4), Eco Brij™ Lauryl-Olyl-Stearyl-Cetyl-Cetearyl based series (HLB 11-18.8 and in some cases acts as either or both a size modifying and a stabilizing surfactant depending on degree of ethoxylation and HLB) and/or combinations thereof.

Compositions of the present invention may be used for removing solids from a solid-liquid mixture. Methods for removing solids from a solid-liquid mixture may comprise adding a composition of the present invention to a solid-liquid mixture, agitating the composition of the present invention with the solid-liquid mixture and then removing the solids from the agitated mixture.

In some embodiments of the present invention, the method for removing solids from a solid-liquid mixture may comprise:
a) mixing a cationic polyacrylamide polymer with a cationic polymer surfactant aggregate, thereby forming a conditioned flocculant;
b) agitating the conditioned flocculant with the solid-liquid mixture, thereby forming an agitated mixture; and
c) removing solids from the agitated mixture.

In some preferred embodiments, the method further comprising mixing a stabilizing surfactant with the cationic polymer surfactant aggregate.

In some other preferred embodiments, the method further comprises mixing a size modifying surfactant with the cationic polymer surfactant aggregate.

In some preferred embodiments, the method further comprising mixing a stabilizing surfactant and a size modifying surfactant with the cationic polymer surfactant aggregate.

In some illustrative embodiments of methods of the present invention, the stabilizing surfactant is mixed with the cationic polymer surfactant aggregate prior to mixing the cationic polyacrylamide polymer with the cationic polymer surfactant aggregate. In some other preferred embodiments, the stabilizing surfactant and cationic polyacrylamide polymer are mixed concurrently with the cationic polymer surfactant aggregate.

In some illustrative embodiments of methods of the present invention, the size modifying surfactant is mixed with the cationic polymer surfactant aggregate prior to mixing the cationic polyacrylamide polymer with the cationic polymer surfactant aggregate. In some other preferred embodiments, the size modifying surfactant and cationic polyacrylamide polymer are mixed concurrently with the cationic polymer surfactant aggregate.

In some illustrative embodiments of methods of the present invention, the stabilizing surfactant and the size modifying surfactant is mixed with the cationic polymer surfactant aggregate prior to mixing the cationic polyacrylamide polymer with the cationic polymer surfactant aggregate. In some other preferred embodiments, the stabilizing surfactant and the size modifying surfactant and cationic polyacrylamide polymer are mixed concurrently with the cationic polymer surfactant aggregate.

Polyacylamides suitable for use in the present invention may be mixed with cationic polymer surfactant aggregates using any preparation method known to a person of skill in the art, such as inverse emulsion polymerization, brine dispersion or as a dry polyacrylamide.

In some illustrative embodiments of methods according to the present invention, removing solids comprises filtration, centrifugation, gravity separation, flotation, skimming, electromagnetic attraction and/or any combination thereof.

### EXAMPLES

The following examples are illustrative of some of the embodiments of the invention described herein. These examples do not limit the spirit or scope of the invention in any way.

### Methods and Materials

Triton™ X-305 (CAS #9002-93-1, TX305) and Triton™ CG-110 (CAS #68515-73-1) an alkyl polyglucoside (APG) were purchased from Sigma Aldrich. CPAM Hyperdrill™ CP911 and CPAM Hyperdrill™ CP911H (desalted polymer) was purchased from SNF with 80% charge density and medium molecular weight. CPAM Praestol™ 835 BS (CAS #372543) with medium charge density and high molecular weight, CPAM Praestol™ 853 BC CAS (#790265) with very high charge density and high molecular weight, CPAM Praestol™ 859BS (CAS #380868) with extremely high charge density and high molecular weight were purchased from Solenis. Polygylcerol surfactants with 3-10 repeating glycerol units and 6-18 carbonyl alkyl chain length were purchased from Jinan Dowin chemical technology Co. Ltd. The mixtures of polyglycerol surfactants have the following hydrophilic-lipophilic balance (HLB) values: PG3-C/PG10-S with HLB values of 10/12, respectively, PG6-C/PG10-C/PG10-L have HLB values of 14/15/16, respectively. Methyl chloride (CAS #74-87-3) was purchased from Linde. Iodomethane (CAS #74-88-4), cyclohexanone (CAS #108-94-1), and 3-(dimethylamino)-1-propylamine (CAS #109-55-7) were purchased from Sigma Aldrich. Tergitol™ 15-S-20 solution (TG 15-S-20, CAS #84133-50-6, TG 15-S-20), Tween™ 20 (CAS #9005-64-5) and APG (Triton™ CG-110, CAS #68515-73-1) were purchased from Sigma Aldrich. Bio-soft™ N91-8 (BS N91-8, CAS #68439-46-3) was received from Stepan. Tergitol™ 15-S-40 (TG 15-S-40, CAS #84133-50-6) was received from DOW. FLOPAM™ FO 4808SSH with 80% charge density and very high molecular weight was purchased from SNF.

Cationic Polymer: General Synthesis for [SMA_{Quat} 72511 or [SMA_{Quat} 725]Cl

Styrene maleic anhydride (3:1 copolymer, 420 g, 23.9% maleic anhydride co-monomer content), 3-(dimethylamino)-1-propylamine (128 mL, 104.6 g, 1 eq) and 1 L of cyclohexanone were combined at ambient temperature. The mixture was heated to ca. 160° C. and refluxed for an additional 3-6 h after all polymer was dissolved. A thick yellow/orange syrup was obtained and let cool to ambient temperature. A 20% SMA-1 solution was created by combining equal volumes of 40% SMA-1 and acetone. An aliquot was transferred to a high-viscosity mixer and combined with methyl iodide (1.0 eq) or methyl chloride (1.0 eq), respectively. Mixing at 100 rpm for 10 minutes generated an entangled white or off-white polymer. Approximately 50% solvent could be decanted from the vessel. The polymer can be dried without washing or can be washed with acetone.

Cationic Polymer: General Synthesis for [SMA_{Quat}-Cumene Terminated 725]I or [SMA_{Quat}-cumene terminated 725]CI

A cumene-terminated SMA 3:1 copolymer (SMA-725C), 50.0 g, 23.9% maleic anhydride (MA) comonomer content, 12.0 g, 0.12 mol) was added to cyclohexanone (300 mL, BP=156° C.) to create a solution with a concentration of ca. 16%. This mixture was refluxed until a light-yellow solution was obtained. The reaction was cooled to ambient temperature before 3-(dimethylamino)-1-propylamine (1 eq with respect to MA, 12.5 g, 15.2 mL) was added dropwise, causing the solution to become dark yellow or orange. The mixture was refluxed using a water-cooled condenser and heating mantle for a minimum of 3 hours, or until full conversion was observed by FT-IR spectroscopy, before cooling to ambient temperature. An aliquot (ca. 5 mL) was removed and dried in a vacuum oven at 60° C. overnight or until constant weight. Analysis by IR spectroscopy was consistent with non-cumene terminated variants, and full conversion to the ring-closed maleimide product was observed. The product was not isolated before it was converted to the desired quaternary product, as described below.

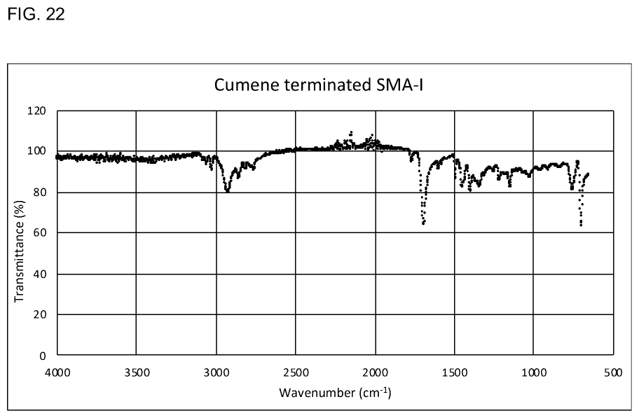

IR (ATR, cm⁻¹): 3058, 3025, 2917, 2911, 1715, 1687, 1491, 1448, 1396, 1340, 1221, 1215, 1146, 1027, 956, 908, 755, 697 (see FIG. 22).

The synthesis of cumene-terminated SMA-Quat was conducted using the solvated cumene-terminated SMA-1 [SMA_{Quat-cumene terminated} 725]I, described above. A solution of [SMA_{Quat-cumene terminated} 725]I (ca. 21% in cyclohexanone, 100 mL) was diluted to a concentration of ca. 10% with acetone (100 mL). The mixture was homogenized at 100 rpm in a high-viscosity mixer heated to 40° C. using an external circulating water bath. The vessel was sealed, and methyl chloride was dosed into the mixer. After short mixing time, the agitator was stopped, and the reaction was allowed to continue for a few minutes. The methyl chloride canister was closed before the pressure was. The vessel was opened, and the yellow liquid was decanted. The white solid was washed with acetone (3×25 mL, with agitation). The solid was dried in vacuo in a high viscosity mixer at 40° C. before drying overnight in a vacuum oven at 70° C. The white solid is water soluble under acidic, neutral, and basic conditions.

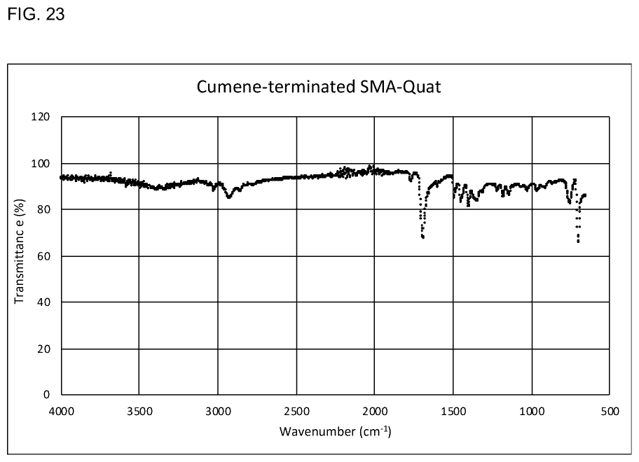

IR (ATR, cm⁻¹): 3056, 3021, 2922, 2851, 1765, 1687, 1599, 1491, 1448, 1398, 1344, 1310, 1213, 1178, 1141, 1060, 1027, 956, 906, 751, 697 (see FIG. 23).

### Particle Size Measurements

The particle size of stabilized NanoNet™ was measured using a Malvern Zetasizer Nano Series instrument. The samples were diluted down to 0.1% (based on SMA_{Quat} 725concentration) and measured using a polystyrene cuvette. The average of three repeating measurements were reported herein.

### Viscosity Measurements

Viscosity of polymers were measured using a Brookfield DV-II+Pro viscometer with a Vane spindle S07 at 30 or 60 rotations per minute (rpm) at ambient temperature. To report viscosity, samples were sheared until the viscosity measurement reached a steady state. After 2 minutes, the viscosity measurement was recorded and reported.

### Preparation of Cationic Polyacrylamide (CPAM) Solutions

Dry CPAM (835, 853, 859, Hyperdrill™ CP911, Hyperdrill™ CP911H) mixtures were prepared at 2%, 3% or 5% w/v of CPAM in distilled (DI) water with the use of a Jiffy mixer and an overhead mixer. For example, in a 2% stock solution, 2 g of the respective PAM was weighed and slowly added to 98 mL of de-ionized (DI) water under constant high-speed mixing at 800-900 rpm to disperse the cationic polyacrylamide (CPAM) throughout the solution. After 5 minutes of mixing, the speed was reduced to 400 rpm and the solution was mixed for 2 hours to allow for full incorporation of the cationic polyacrylamide into solution. For dosing in jar tests, cationic polyacryl amide solutions were diluted to 0.2% CPAM in DI water and vortexed until homogenous.

### Preparation of Cationic Polymer Surfactant Aggregate Solution

To prepare the cationic polymer surfactant aggregate, referred to as “NanoNet™” solution, the SMA_{Quat} 725 as well as different SMA_{Quat} polymers (such as cumene terminated, non-cumene terminated, 130, 150, 230, 725) were dissolved in DI water and refluxed at 90° C. for 3 hours to obtain a 2 wt % or Swt % solution, respectively. The surfactants TC CAB 35 (30% stock in water) or Triton™ X-305 (70% concentration in water) were added to the SMA_{Quat} 725 solution to obtain the desired final concentration of 1 wt % or 2.5 wt %, respectively, and mixed for 2 minutes. Polyglyceryl surfactants (caprylate, laurate, stearate) were added, vortexed and heated at 60° C. for 10 minutes and

### Cooled to Ambient Temperature.

Preparation of CPAM:NanoNet™ Solutions

Samples were prepared by thoroughly mixing the appropriate amount of NanoNet™ (NN) to cationic CPAM solutions (prepared at 2%, 3%, 5% concentration) at a final ratio of 1:0.25, 1:0.4, 1:0.6 and 1:1% ratio of CPAM:NN. The mixture is then vortexed and de-bubbled and equilibrated overnight. All samples were homogeneous prior to testing. These samples were used for viscosity measurements.

The samples were diluted to a constant CPAM concentration for flocculation jar testing. 2% CPAM stock samples were diluted to a final CPAM concentration of 0.2%; in CPAM:NN made with 3% CPAM stock samples were diluted to a final CPAM concentration of 0.3%; and in CPAM:NN made with 5% CPAM stock samples were diluted to a final CPAM concentration of 0.5%. Unless otherwise stated, NanoNet™ A consists of [SMA_{Quat} 725]:[TX305]:[PG3-C][5]:[2.5]:[2]% wt/vol (NN_{A}) and NanoNet™ B consists of [SMA_{Quat} 725]:[Tween™ 20]:[APG][5]:[2]:[2.5] wt/vol %, (NN_{B}).

### Preparation of Kaolin Water Matrix

A kaolin mixture consisting of 0.3% kaolin (Ward's Science, CAS #1332-58-7, 42 g) was added to 14 L tap water at 20° C. and mixed at 200-300 rpm until distributed.

### Coagulation Test in 0.3% Kaolin Water

Coagulation tests were conducted to determine the floc formation capability of the NN. Various doses of the NN were dosed into 6 beakers in a jar test configuration with each containing 400 mL of 0.3% kaolin. The mixtures were stirred for 2 minutes at 200 rpm followed by another minute at 30 rpm. The longer mixing time allows for better coagulation of suspended kaolin particles in the coagulation process. After 5 minutes of settling, the turbidity of the supernatant was measured using an EXTECH instruments TB400 turbidimeter.

### Jar Test and Efficacy Test

Jar tests were conducted using 400 mL of 0.3% kaolin or diluted water matrix A, B, C (1/60 dilution with tapwater) in 600 mL beakers using a VELP Scientifica JLT6 Flocculation Tester. The diluted CPAM or CPAM:NN solutions were added to water matrix A,B, or C, respectively, via a Hamilton glass syringe or 1 mL plastic syringe. The jars are then mixed at 200 rpm for 1 minute. Mixing is then halted, and the mixture inside the jars were allowed to settle for 45 seconds. The last minute of this process was recorded and analyzed using video analysis to determine the relative settling rate of each respective jar, which was then plotted against CPAM dosage.

Flocculation of concentrated water matrix A, B or C (5 mL water matrix mixed in 45 mL tap water with a total volume of 50 mL) was tested by adding desired amount of diluted CPAM or CPAM:NN and inverting the sample vial after every addition until the floc formation appeared. The optimum floc dosage was reported where visible flocs and phase separation of the water matrix was observed.

In case of oily sludge system (water matrix D), matrix water was diluted down with water at 1:1 ratio and stirred continuously. Then, 10 mL of diluted matrix water was transferred to 15 mL centrifuge tubes and diluted CPAM or CPAM:NN were added to determine the optimum dosage to fully flocculate the sludge. To facilitate agitation and flocculation, the falcon tubes were inverted gently 20 times post flocculant addition. The drainage rate of sludge was recorded over time by using a 100 micron pore size sieve. The volume of drained water into a graduated cylinder was recorded at different time intervals of 10 seconds to 60 minutes. The turbidity of drained water was measured using a EXTECH instruments TB400 turbidimeter.

### Rheological Properties of NanoNet™ Solutions

For rheometer measurements a Thermo HAAKE Rheoscope 1 rheometer was applied with a spindle geometry of 20 mm diameter and a 1° cone angle (C20/1). The experiments were conducted at ambient temperature with a strain amplitude of 0.001-10 and a frequency of 1 Hz.

### Water Compositions

Solid content of different water matrix was measured by developing a mass balance according to the following: (net weight of dry specimen/original weight of specimen)*100 (Hamilton, D., & Zhang, H. (2011). Solids content of wastewater and manure. Oklahoma Cooperative Extension Service.)

### Water Matrix A.

Water matrix A is a mature fine tailings water purchased from the Canada Oil Sands Innovation Alliance with a neat solids content of 34.7%.

TABLE 1
dissolved cationic ions in Water matrix A.

| Component | Composition (mg/L) |
|---|---|
| Na | 737.3-815.4 |
| Al | 34.7-43.3 |
| Si | 104.1-173.5 |
| Fe | 34.7-60.7 |
| Mg | 17.3 |
| Ca | 52.0-60.7 |

### Water Matrix B.

Water matrix B is a mature fine tailings water purchased from the Canada Oil Sands Innovation Alliance with a neat solids content of 38.2%.

TABLE 2
dissolved cationic ions in Water Matrix B.

| Component | Composition (mg/L) |
|---|---|
| Na | 754.4-783.1 |
| Al | 105.0 |
| Si | 114.6-124.1 |
| Fe | 57.3-66.8 |
| Mg | 19.1 |
| Ca | 38.2-66.85 |

### Water Matrix C.

Water matrix C is a mature fine tailings water purchased from the Canada Oil Sands Innovation Alliance with a neat solids content of 34.4%.

TABLE 3
dissolved cationic ions in Water Matrix C.

| Component | Composition (mg/L) |
|---|---|
| Al | 266.6 ± 60.2 |
| Si | 782.6 ± 172 |
| Fe | 77.4 ± 17.2 |
| Mg | 8.6-17.2 |
| Ca | 43-51.6 |

### Water Matrix D.

Water matrix D is an oily sludge composed of drill cuttings waste from Alberta, Canada with a neat solids content of 17.9%.

TABLE 4
dissolved cationic ions in Water Matrix D.

| Component | Composition (mg/L) |
|---|---|
| Na | 2331.4 |
| Mg | 26.8 |
| Fe | 71.6 |
| Ca | 187.9 |

### Synthetic Water

A synthetic kaolin water is used to assess flocculation performance in a jar test configuration. A kaolin mixture consisting of 0.3% kaolin (Ward's Science, CAS #1332-58-7) was prepared in tap water.

### ICP Analysis

Inductively coupled plasma—optical emission spectrometry (ICP-OES) analysis of water samples was performed on an Agilent 5110 spectrometer. The samples were digested treating 0.5 mL of water matrix in 1 mL of 70% nitric acid and heated in the water bath at 60° C. for 45 minutes. After digestion, the samples were diluted in 3.5 mL of 1 M nitric acid and ran on the instrument. The ICP was set to a radial viewing mode at 8 mm and a standard intellquant reading. The chemical composition of samples was detected and reported as a mg/L basis. The sample waters A-D were diluted to reach a final solids concentration of 0.04%.

### Description of Image Analysis

An image analysis software was used to quantify the apparent relative settling rate of flocculated solids in a standard jar test apparatus. Jar tests experiments are often used during bench-scale testing to qualitatively compare solids separation efficacy of two or more flocculants. This image analysis routine provides a robust and facile method to quantitatively compare efficacy of different flocculants via their measured relative settling rates across a full dose curve. A camera (Angetube 920U) was used to capture the settling videos following flocculant addition and sample mixing with all the camera settings (e.g., exposure) manually set. The camera parameters were configured to maximize the contrast between the turbid raw water sample and the background behind the beakers. To measure relative settling rate, a region of interest (ROI) spanning the beaker width and positioned between the top of the fluid and the top of the impeller blade is tracked over time. From this ROI, the average grayscale pixel intensity is measured at each time point. The average grayscale pixel intensity is a measure of brightness and provides an indicator of water clarity. The average grayscale pixel intensity values over time (effective water clarity versus time) are then fit to a sigmoid function to determine the slope parameter coefficient which is an indicator of relative settling rate. The software was not calibrated to estimate floc size, though it can be generally inferred that for the systems tested, larger flocs result in a faster relative settling rate.

### Stability Analysis and Shelf-Life

Accelerated shelf life takes the climatic conditions to more extreme levels to compress required test time. This is performed by applying the Arrhenius equation to determine the rate of acceleration of time based on increased temperatures. The accelerated aging process is based on the relationship of temperature and reaction rate where an increase in temperature increases the reaction rate. According to ASTM-F1980 standard, using Q₁₀=2.0, 5.3 weeks of storage at 55° C. is equivalent to 1 year of product storage at 22° C. (Bandara, P. C., et al. (2019). Impact of water chemistry, shelf-life, and regeneration in the removal of different chemical and biological contaminants in water by a model Polymeric Graphene Oxide Nanocomposite Membrane Coating. Journal of Water Process Engineering, 32, 100967). The samples were tightly sealed in a glass vial and stored at 55° C. to mimic up to 6 months of storage and viscosity/efficacy of samples in 0.3% kaolin compared to the fresh sample is measured.

### Example 1: Increasing Cationic Polymer Surfactant Aggregate Diameter by Addition of Polyglycerol Surfactants to Cationic Amphipathic Co-Polymers Favors Coagulation Efficacy

TABLE 5
Cationic polymer surfactant aggregate diameter and turbidity removal
of 0.3% kaolin at 5 ppm of [SMA_{Quat} 725]:[stabilizing surfactant]:[size
modifying surfactant]. Particle aggregate diameter was determined
using a Malvern ZetaSizer. Turbidity removal was determined by jar
tests in respect to the turbidity of kaolin (1100-1200 NTU).

| | | Particle | Turbidity |
|---|---|---|---|
| [polymer]:[Stabilizing Surfactant]:[Size | | Aggregate | removal of |
| modifying surfactant], Ratio (%) | | diameter (nm) | kaolin (%) |
| [SMA_{Quat} 725]:[TX305]:[PG3-C] | 2:1:0.4 | 36.92 ± 0.27 | 98.2 |
| [SMA_{Quat} 725]:[TX305]:[PG3-C] | 2:1:0.4 | 30.11 ± 0.28 | 98.2 |
| [SMA_{Quat} 725]:[TX305]:[PG6-C] | 2:1:0.4 | 28.16 ± 0.05 | 97.3 |
| [SMA_{Quat} 725]:[TX305]:[PG10-C] | 2:1:0.4 | 28.82 ± 0.31 | 98.1 |
| [SMA_{Quat} 725]:[TX305]:[PG10-L] | 2:1:0.4 | 29.29 ± 0.08 | 97.8 |
| [SMA_{Quat} 725]:[TX305]:[PG10-S] | 2:1:0.4 | 34.04 ± 0.43 | 98.0 |
| [SMA_{Quat} 725]:[TX305] | 2:1 | 30.11 ± 0.28 | 97.9 |
| [TX305] | 1 | 2.4 ± 0.01 | 3 |
| [SMA_{Quat} 725] | 2 | 30.08 ± 0.05 | 31 |
| [SMA_{Quat} 725] Cumene | 2 | 33.8 ± 0.7 | 35.4 |
| terminated | | | |
| [SMA_{Quat} 725 Cumene | 2:1:0.4 | 38.55 ± 0.5 | 97.8 |
| terminated]:[TX305]:[PG3-C] | | | |

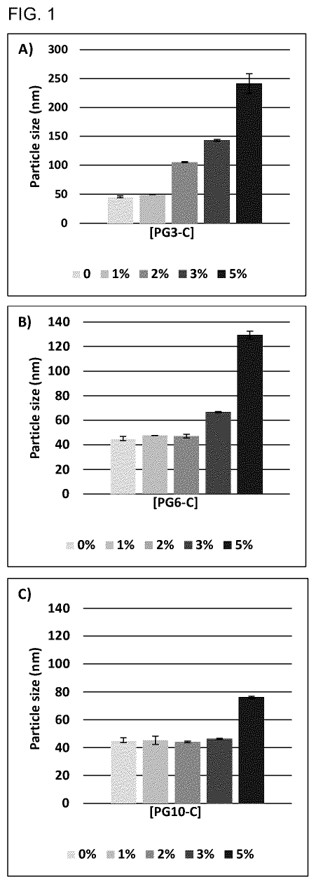

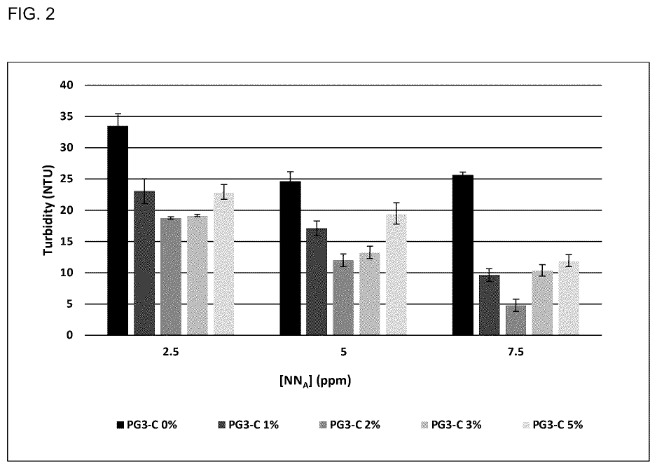

The results from Example 1 are set out in FIGS. 1 and 2, as well as Table 5 and describe the effect of polyglycerol caprylate surfactants on the cationic polymer surfactant aggregate diameter of cationic NanoNet™ [SMA_{Quat} 725]:[Stabilizing surfactant](with TX305 as stabilizing surfactant). Table 5 illustrates that size modifying surfactants with HLB values below 14 in the Triton™ X305 (TX305) system cause significant particle swelling as addition of PG3-C and PG10-S cause larger polymer-surfactant aggregate diameters. As the polymer-surfactant aggregate begins to swell the coagulation performance is maximized; as seen by the greatest performance in removing kaolin turbidity. It appears that the higher diameter of cationic polymer surfactant aggregate leads to better settling of particles.

Particle aggregate diameters of cationic NanoNet™ consisting of SMA_{Quat} 725 and TX305 at a ratio of [5]:[2.5]%, respectively, were measured upon addition of various size modifying polyglycerol surfactants at different concentrations. The addition of the PG3-C surfactant increases the particle aggregate diameter most significantly. PG3-C surfactant concentrations above 5% can lead to possible aggregate formation. The optimum PG3-C surfactant concentration determined, based on this example, is 2%. The addition of PG6-C and PG10-C surfactants up to 3% surfactant concentration indicates little increase in particle aggregate diameter.

The coagulation efficacy of the [SMA_{Quat} 725]:[TX305]:[PG3-C]was tested at varying PG3-C surfactant concentrations. FIG. 2 illustrates the turbidity removal of [SMA_{Quat} 725]:[TX305]:[PG3-C][5]:[2.5]:[0-5]% in 0.3% kaolin in a jar test configuration at various cationic NanoNet™ dosing. The composition with 2% PG3-C achieved highest coagulation efficacy and demonstrates the lowest turbidity values. A concentration of 7.5 ppm coagulant dosed in kaolin water displays the lowest turbidity value to 4.8-5 NTU. It was found that the improved coagulation efficacy occurred with formulations that first demonstrated particle size growth; [SMA_{Quat} 725]:[TX305]:[PG3-C][5]:[2.5]:[2]%.

### Example 2: Boost in Performance of Cationic Polyacrylamide with Different Charge Densities Upon Addition of Cationic Polymer Surfactant Aggregate

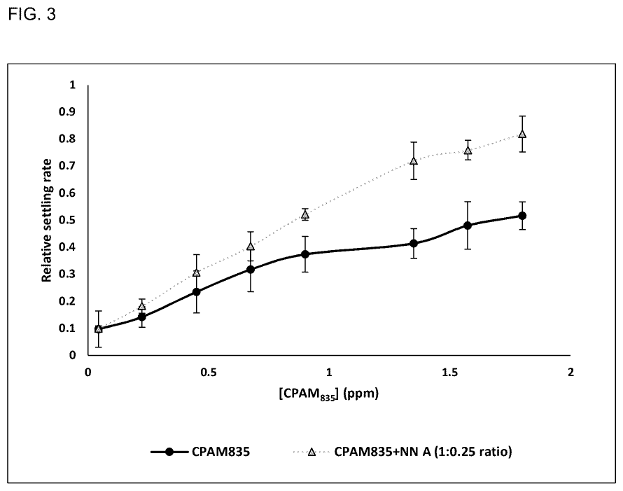

The results of Example 2 are set out in Tables 6A to 6D and in FIG. 3. Tables 6A-6D: Improvement of CPAMs with different charge densities upon addition of NanoNet™ on diluted water matrix A (1 in 60 dilution). CPAM 835 is a medium charge density and high molecular weight cationic polyacrylamide. CPAM 853 is a very high charge density and high molecular weight cationic polyacrylamide. CPAM 859 is an extremely high charge density and high molecular weight cationic polyacrylamide. CPAM Hyperdrill™ CP911 and CPAM Hyperdrill™ CP911H (the desalted polymer), both with 80% charge density and medium molecular weight are cationic polyacrylamide polymers. All CPAMs are made at 2% wt. stock and NanoNet™ was added to obtain the desired ratio of CPAM:NN. NanoNet™ contains [SMA_{Quat} 725]:[TX305]:[PG3-C][5]:[2.5]:[2]%.

TABLE 6A

CPAM 835:NN

| | 1:0.25 | 1:0.4 | 1:0.6 | 1:1 |
|---|---|---|---|---|
| Improvement (%) | 43.7 | 44.0 | 55.5 | 61.1 |

TABLE 6B

CPAM 853:NN

| | 1:0.25 | 1:0.4 | 1:0.6 | 1:1 |
|---|---|---|---|---|
| Improvement (%) | 26.9 | 28 | 38.5 | 42.3 |

TABLE 6C

CPAM 859:NN

| | 1:0.25 | 1:0.4 | 1:0.6 | 1:1 |
|---|---|---|---|---|
| Improvement (%) | 18.2 | 19.0 | 36.0 | 40.9 |

TABLE 6D

| | CPAM Hyperdrill ™ | | | | CPAM Hyperdrill ™ | | | |
|---|---|---|---|---|---|---|---|---|
| | CP911:NN | | | | CP911H:NN | | | |
| | 1:0.25 | 1:0.4 | 1:0.6 | 1:1 | 1:0.25 | 1:0.4 | 1:0.6 | 1:1 |
| Improvement | 32.0 | 33.3 | 35.0 | 40 | 33.3 | 42.2 | 46.7 | 48.0 |
| (%) | | | | | | | | |

Tables 6A to 6D tabulate the effect of NanoNet™ ratio on the flocculation efficacy of different CPAM in respect to the charge density of the CPAM. Improvement % is based on the relative settling rate difference of CPAM alone versus CPAM:NN after flocculation of diluted water matrix A. The results indicate that performance of flocculant increases with increasing NN_{A} concentration until the system is saturated, at which point further addition of NN_{A} does not increase flocculation performance. Also, addition of NanoNet™ A to lower charge density CPAM 835 appears to show the greatest improvement (43-61%, Table 6A).

FIG. 3 illustrates the relative settling rate of medium charge CPAM 835 and its boosting with addition of 1:0.25 ratio of NanoNet™ dosed in kaolin. The results suggest a 50% improvement in the performance of CPAM:NN compared to CPAM alone in order to achieve the same relative settling rate (calculated based on ppm relative settling rates at different CPAM dosing).

### Example 3: Rheological Changes of Cationic Polyacrylamide Combined with Cationic Polymer Surfactant Aggregate

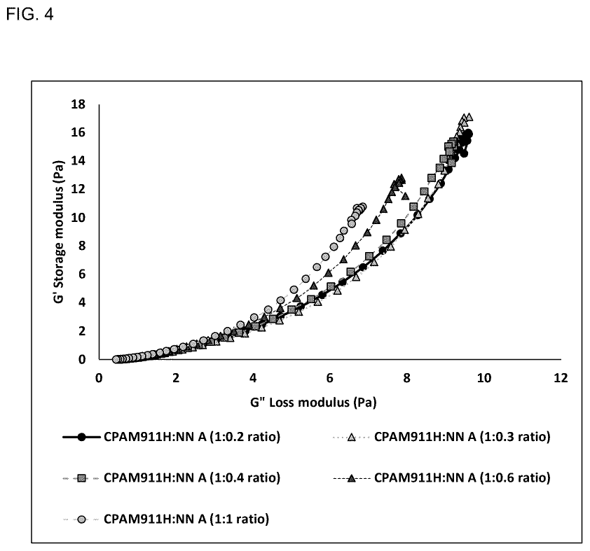

The results of Example 3 are set out in FIG. 4. FIG. 4 illustrates the rheological properties of CPAM Hyperdrill™ CP911H with different NanoNet™ ratio, as determined by young and loss modulus. The slope of Han plot G′/G″ indicates the apparent microstructural changes, where G′>G″ material shows a highly structured matrix (Li, C. et al. 2017. SiC-fixed organophilic montmorillonite hybrids for poly (phenylene sulfide) composites with enhanced oxidation resistance. RSC advances, 7(74), 46678-46689). The results show that increasing NanoNet™ solution concentration in CPAM gel makes a less solid-like behavior in the network. The viscosity also validates this by a decrease in viscosity value, where viscosity of 2% CPAM (3100 cP) drops to 2500 cP by adding CPAM:NN 1:0.3%. Viscosity is measured at 60 rpm. Decreases in viscosity are advantageous for dosing and material handling when applying the flocculant formulation through dosing pumps.

### Example 4: Floc Stability of Cationic Polyacrylamide Combined with Cationic Polymer Surfactant Aggregate with Shear Over Time

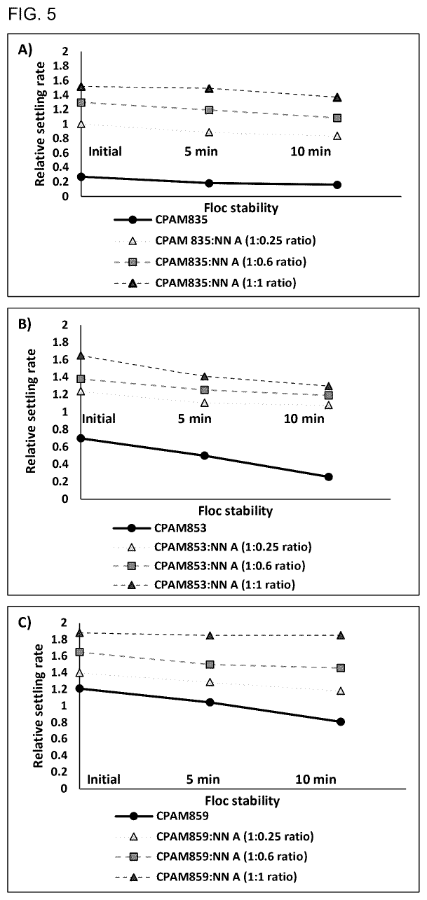

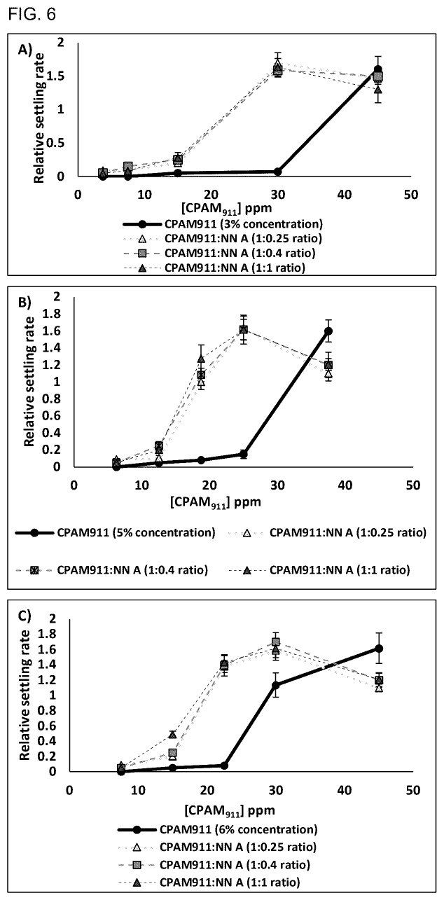

The results of Example 4 are set out in FIGS. 5 and 6, as well as Table 7. Generally, it is shown that a system containing the cationic polymer surfactant aggregate “NanoNet™ A” illustrates improvements in floc strength.

TABLE 7
Floc stability of CPAM859:NN_{A} and CPAM859:NN_{A} by shear over time
measured by the turbidity of water matrix A supernatant after
floc settling. Flocs are initially formed, and turbidity was
measured right after settling, then flocs are sheared for 5
min and settled to measure the turbidity. In the last step,
flocs are sheared for another 5 min and settled to measure
the turbidity. Shearing occurred at 200 rpm in this
experiment. CPAM 835 is a medium charge density and
high molecular weight cationic polyacrylamide. CPAM
853 is a very high charge density and high molecular
weight cationic polyacrylamide. All CPAMs were
prepared at 2% wt. stock and NN_{A} was added to
obtain the desired ratio of CPAM:NN_{A}. NN_{A}
contains [SMA_{Quat} 725:TX305:PG3-C] [5:2.5:2]%.

| | CPAM835:NN_{A} | | | | CPAM859:NN_{A} | | | |
|---|---|---|---|---|---|---|---|---|
| | 1:0 | 1:0.25 | 1:0.6 | 1:1 | 1:0 | 1:0.25 | 1:0.6 | 1:1 |
| Turbidity | 46.0 | 0.0 | 0.0 | 0.0 | 0.3 | 0.0 | 0.0 | 0.0 |
| immediately | | | | | | | | |
| after settling | | | | | | | | |
| Turbidity after | 55.1 | 0.0 | 0.0 | 0.1 | 3.2 | 0.0 | 0.4 | 0.1 |
| 5 min shear | | | | | | | | |
| Turbidity after | 72.3 | 0.0 | 0.1 | 0.9 | 7.3 | 0.0 | 0.5 | 0.5 |
| 10 min shear | | | | | | | | |

Table 7 and FIG. 5 illustrate the floc strength versus shear overtime indiluted water matrix A. The flocs are initially formed after addition of CPAM or CPAM:NN_{A} and settled, sheared for 5 min and settled, then sheared for another 5 min and settled. The results of turbidity and relative settling rate are reported at these three stages. Minimal changes are observed in turbidity with CPAM:NN_{A} samples after 10 min of shearing. However, flocs formed by CPAM alone broke and increased the turbidity overtime. Addition of NanoNet™ to CPAM also helps to maintain the high relative settling rate as opposed to CPAM system (see FIG. 5). Flocs formed by all three different CPAM:NN_{A} ratios appear to be less prone to breakage with shear over time.

### Example 5: Addition of Cationic Polymer Surfactant Aggregate “NanoNet™” Provide Similar Boost in the Performance of Cationic Polyacrylamide with Different Concentrations

The results of Example 5 are illustrated in FIG. 6. FIG. 6 illustrates the effect of CPAM concentration with different ratios of NanoNet™ on the relative settling rate of diluted water matrix A. Addition of NanoNet™ consistently increases the relative settling rate at lower CPAM concentrations, regardless of CPAM concentrations (3-6%).

### Example 6: Improvement in Required Dosing of Cationic Polyacrylamide Combined with Cationic Polymer Surfactant Aggregate in Flocculation of Concentrated Mature Fine Tailings and Oily Sludge

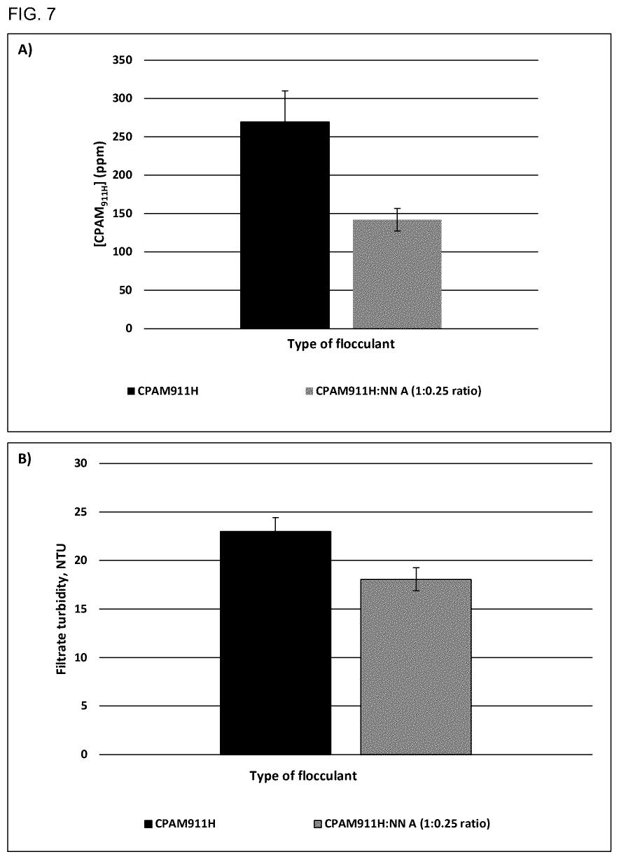

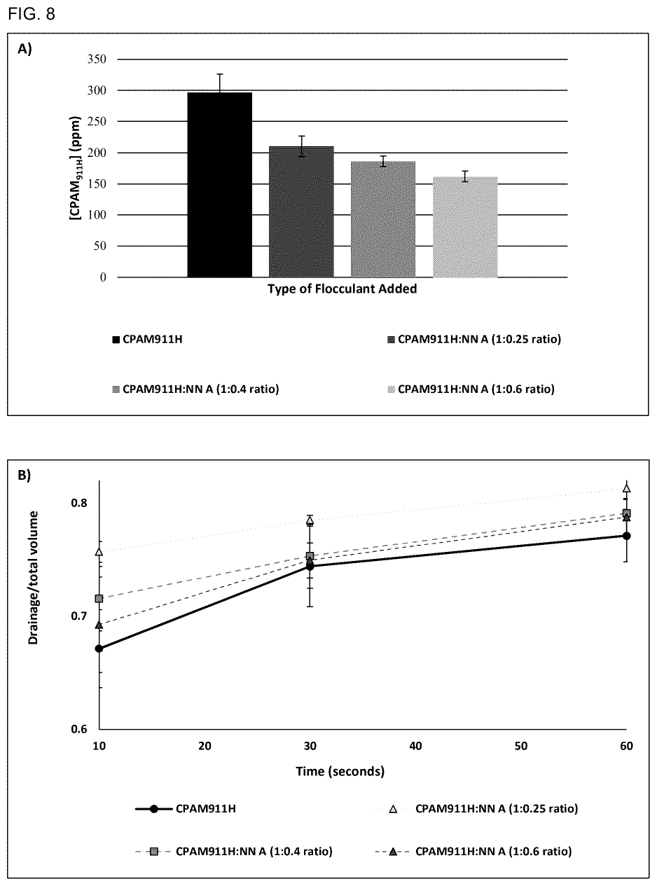

The results of Example 6 are displayed in FIGS. 7, and 8. FIG. 7 illustrates the flocculation of water matrix D at optimum dosage. Addition of NN_{A} decreases CPAM 911H consumption by 47.5% and filtrate turbidity after drainage/dewatering of sludge also indicates lower values when NN_{A} is added. FIG. 8 illustrates the optimum dosage required to fully flocculate the concentrated water matrix C (1:1 dilution). The results show that the higher the NanoNet™ A concentration in the system, the lower the consumption of CPAM 911H (optimum dosage shifts from 297 ppm to 162 ppm). The drainage or dewatering experiments (FIG. 8B) also reveals that addition of NanoNet™ A improves the drainage of water which is an important parameter in sludge dewatering applications. The best performing mixture appear to be the CPAM911H:NN_{A} (1:0.25) ratio.

### Example 7: Stability and Shelf Life of Cationic Polyacrylamide Combined with Cationic Polymer Surfactant Aggregate “NanoNet™”

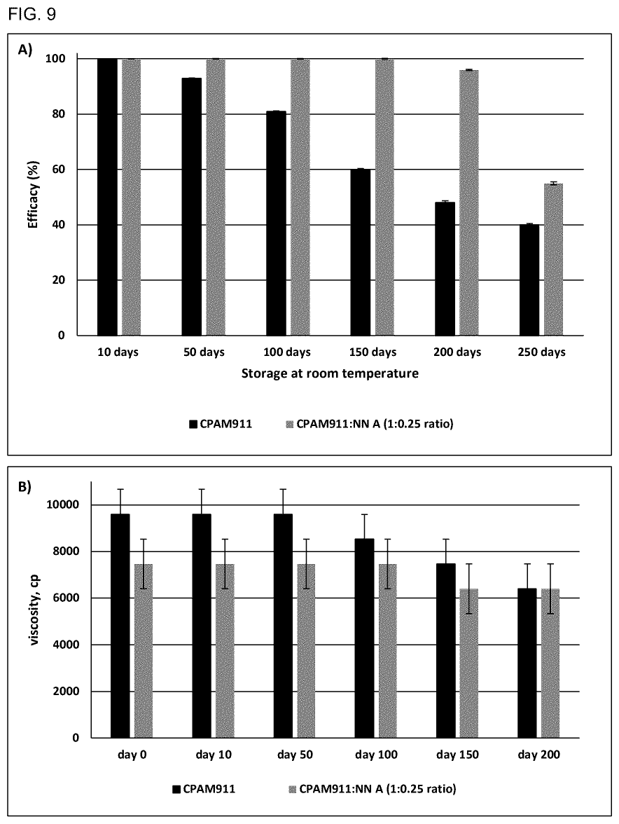

The results of Example 7 are illustrated in FIG. 9. FIG. 9 evaluates the shelf life and stability of CPAM911H:NN_{A} in the accelerated aging environment (1 day @55° C.=10 days room temp). Stability of samples are tested against 0.3% kaolin. Addition of NanoNet™ A to CPAM 911H forms stable 5 products with minimal changes to efficacy and viscosity up to 5 months, while that of CPAM alone starts to show signs of substantial degradation after 50 days.

### Example 8: Formulation of Cationic Polymer Surfactant Aggregate with Sustainable Surfactants

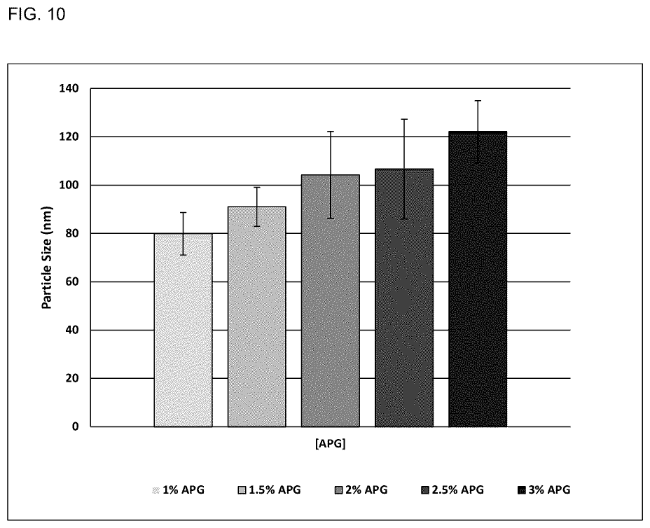

The results of Example 8 are set out in FIG. 10 and Table 8. Table 8 sets out sustainable surfactants screening to form green NanoNet™. Particle aggregate diamter and turbidity removal of 0.3% kaolin after 5 m of settling at 5 ppm of [SMA_{Quat} 725][surfactant]. Particle aggregate diameter determined by ZetaSizer and turbidity removal as determined by jar tests in respect to the turbidity of kaolin alone (1100-1200 NTU).

TABLE 8

| | | Particle | Turbidity |
|---|---|---|---|
| | | aggregate | removal |
| | | diamter, | of kaolin, |
| [polymer]:[Sustainable Surfactant] | | nm | % |
| [SMA_{Quat} 725]:[Span20]* | 5:1 | 170.30 | 98.4 |
| | 5:1.5 | 654.66 | 98.1 |
| | 5:2 | 730.93 | 98.3 |
| | 5:2.5 | 441.06 | 98.1 |
| | 5:3 | 394.6 | 99.0 |
| [SMA_{Quat} 725]:[Tween ™ 20] | 5:1 | 20.81 | 98.3 |
| | 5:1.5 | 24.77 | 99.6 |
| | 5:2 | 28.18 | 99.4 |
| | 5:2.5 | 25.89 | 99.2 |
| | 5:3 | 24.96 | 99.2 |
| [SMA_{Quat} 725]:[Tween ™ 40] | 5:1 | 23.69 | 96.5 |
| | 5:1.5 | 22.24 | 98.2 |
| | 5:2 | 22.27 | 98.2 |
| | 5:2.5 | 22.50 | 98.0 |
| | 5:3 | 22.50 | 98.4 |
| [SMA_{Quat} 725]:[Tween ™ 60] | 5:1 | 29.99 | 98.1 |
| | 5:1.5 | 29.80 | 97.4 |
| | 5:2 | 30.72 | 98.1 |
| | 5:2.5 | 32.69 | 97.9 |
| | 5:3 | 34.71 | 98.5 |
| [SMA_{Quat} 725]:[Tween ™ 80] | 5:1 | 22.29 | 98.2 |
| | 5:1.5 | 25.83 | 99.0 |
| | 5:2 | 41.40 | 98.8 |
| | 5:2.5 | 47.92 | 98.3 |
| | 5:3 | 54.00 | 99.2 |
| [SMA_{Quat} 725]:[Tween ™ 85]** | 5:1 | 79.08 | 98.4 |
| | 5:1.5 | 93.07 | 98.2 |
| | 5:2 | 116.9 | 98.3 |
| | 5:2.5 | 80.95 | 98.1 |
| | 5:3 | 91.80 | 98.4 |
| [SMA_{Quat} 725]:[APG] | 5:1 | 106.3 | 100 |
| | 5:1.5 | 106.0 | 99.9 |
| | 5:2 | 198.8 | 100 |
| | 5:2.5 | 165.9 | 99.9 |
| | 5:3 | 102.62 | 100 |

*Samples aggregated. Particle size measurements are not accurate.
**Samples aggregated. Particle size measurements are not accurate.

Table 8 provides evidence of the interaction of SMA_{Quat} 725 5% with different green surfactants to form green NanoNet™. Turbidity removal is tested in 0.3% kaolin and reduction in the turbidity after settling was reported. HLB value of SPAN 20 is 8.6, Tween™ 20 is 17, Tween™ 40 is 15-16, Tween™ 60 is 14.9, Tween™ 80 is 15, Tween™ 85 is 11 and APG is 12-13 (Iglauer, S., Wu, Y., Shuler, P. J., Blanco, M., Tang, Y., & Goddard, W. A. (2004, April). Alkyl polyglycoside surfactants for improved oil recovery. SPE/DOE Symposium on Improved Oil Recovery. OnePetro). As expected, the high HLB surfactant Tween™ 20 provided the most stable and smallest particle aggregate diameter (approximately 20 nm, Table 8). Particle size increased with effective HLB value (SPAN 20>Tween™ 85>APG>Tween™ 60>Tween™ 80>Tween™ 40>Tween™ 20). It was found that surfactants with HLB values below 12 eventually aggregated, while surfactants with HLB between 12 and 15 began to gel at higher concentrations (approaching 3%); confirming that these surfactants were not effective stabilizing surfactants. To form a balanced NanoNet™; APG (Triton™ CG-110) was selected as a size modifying surfactant due to its low HLB value, high turbidity removal and large particle aggregate diamter in the experiments presented in Table 8. Tween™ 20 was selected due to its strong stabilizing effect and small particle size as a stabilizing surfactant. Thus, system containing SMA_{Quat} 725, Tween™ 20 and APG (as stabilizing surfactant and size modifying surfactant, respectively) was formed and optimized in the following section. Overall, results shown above indicate that surfactants with HLB>14-15 are applicable as stabilizing surfactants. Surfactants with HLB<14-15 are used as size modifying surfactants.

FIG. 10 illustrates that addition of higher amount of APG in [SMA_{Quat} 725]:[Tween™ 20]5:2% system lead to larger particle sizes of NanoNet™. However, samples solidify at APG>2.5%, indiciating that the surfactant balance in the NanoNet™ is important for stability and activity.

### Example 9: Improvement in Performance of Cationic Polyacrylamide Mixed with Green Cationic Polymer Surfactant Aggregate (NanoNet™ B)

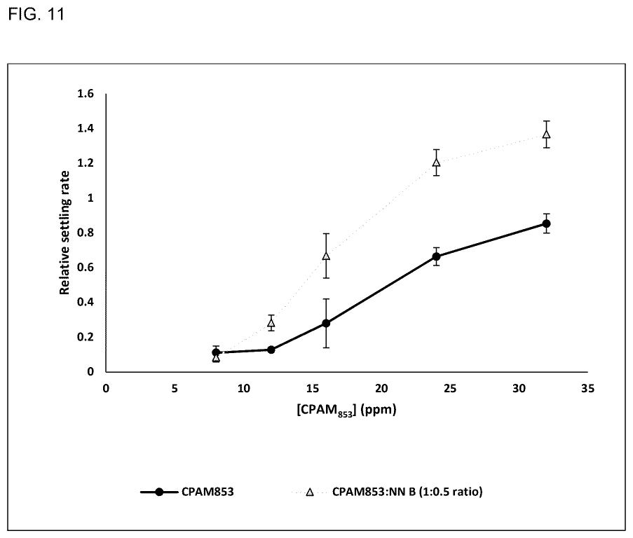

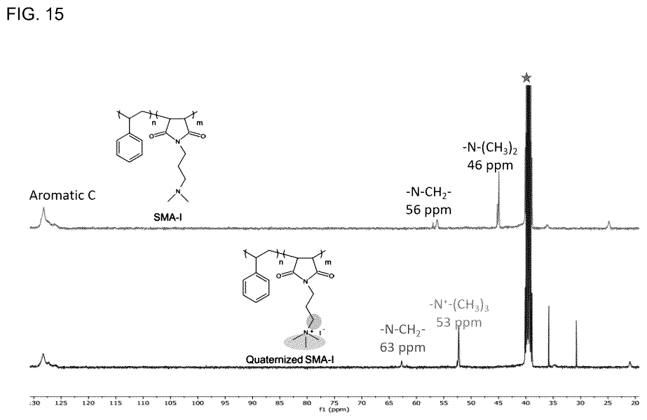

The results of Example 9 are set out in FIGS. 11 to 20, as well as Table 9. Table 9: CPAM Hyperdrill™ CP911H:NN (1:0.25% ratio) with [SMA_{Quat} 725]:[Tween™ 20]5:2% and various [APG] ratios of 1-3% at 18 ppm in diluted water matrix A (1 in 60 dilution).

TABLE 9

[APG]

| | 1% | 1.5% | 2% | 2.5% | 3% |
|---|---|---|---|---|---|
| Improvement (%) | 46.0 | 46.4 | 48.4 | 64.2 | 43.7 |

Table 9 shows that addition of APG up to 2.5% in [SMA_{Quat} 725]:[Tween™ 20][5]:[2]% system improves the relative settling rate at a constant concentration of CPAM 853. The improvement diminish at [APG]3% due to aggregation of sample, highlighting the importance of NanoNet™ stability during the formulation process.

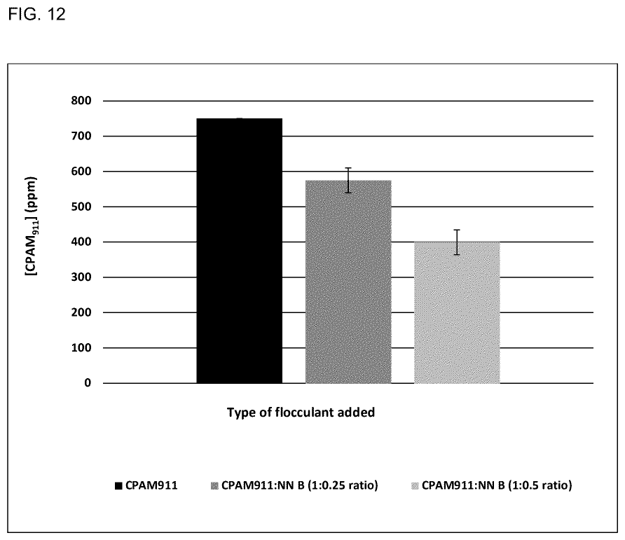

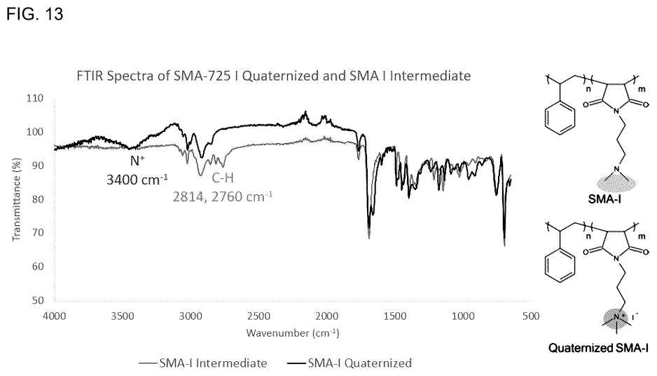

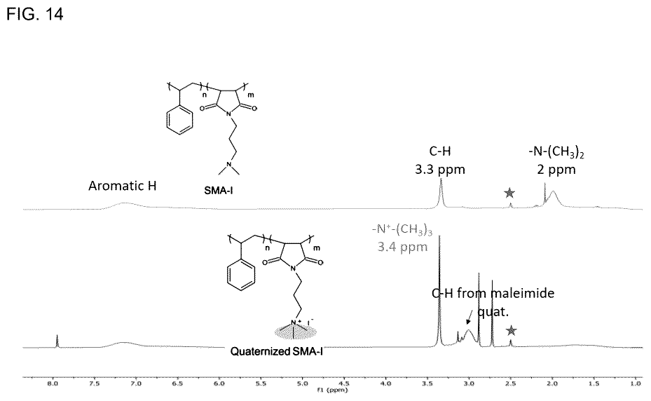

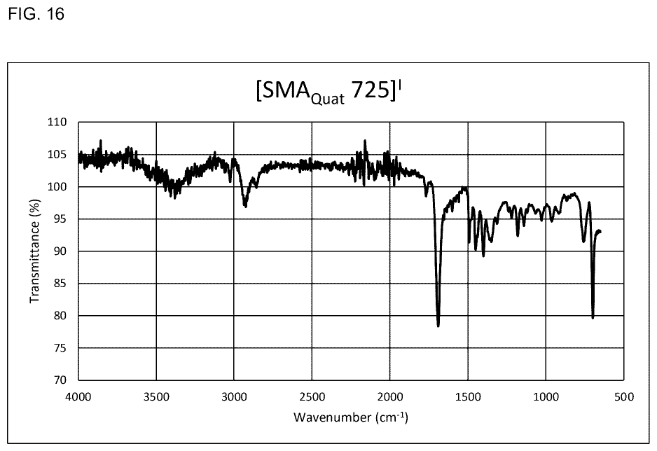

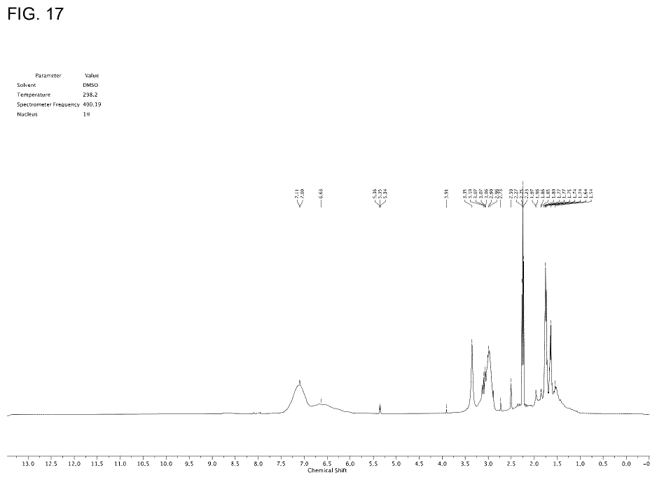

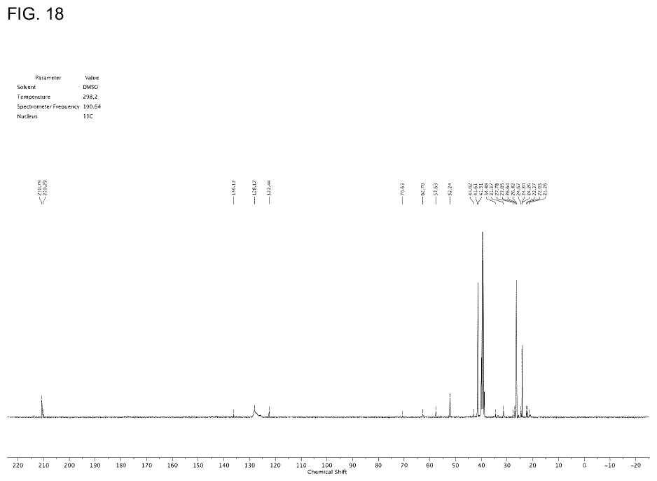

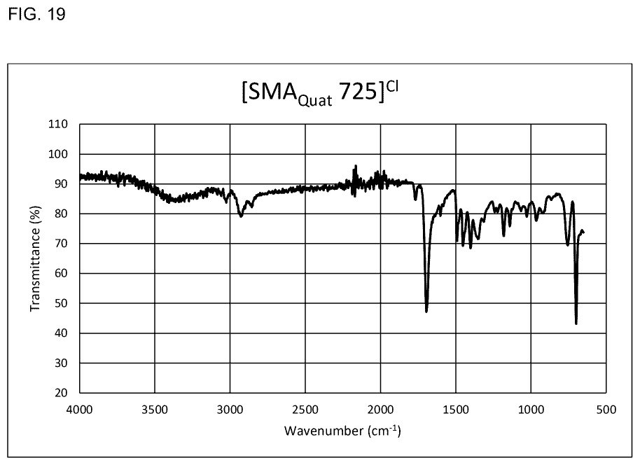

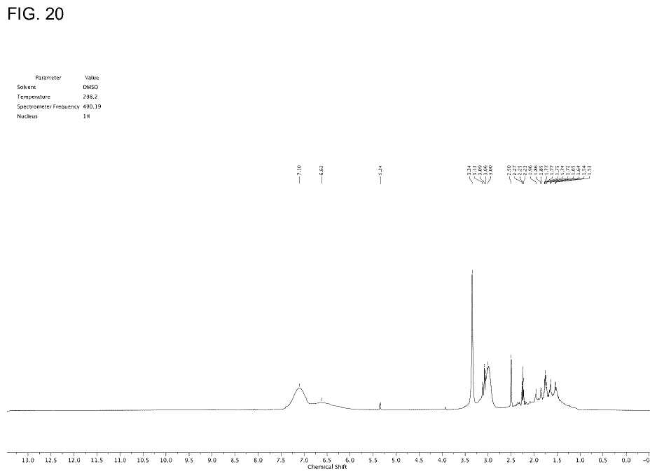

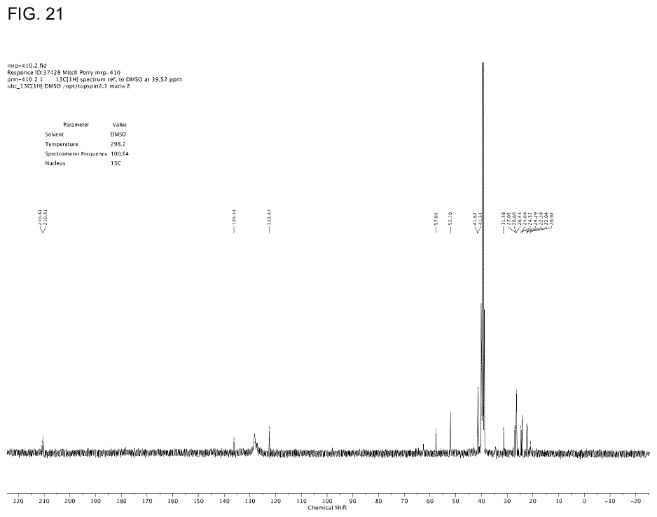

FIG. 11 illustrates the advantage of NanoNet™ addition to CPAM 853 in matrix water B. Results indicate 50% boost in the performance to achieve a constant relative settling rate. FIG. 12 shows the dosage required to fully flocculate water matrix D (750 ppm in case of CPAM 853, 575 ppm in case of CPAM 853:NN_{B} (1:0.25 ratio), 400 ppm in case of CPAM 853:NN (1:0.5 ratio)). The consumption of CPAM decreased 46.7% upon as the ratio of NanoNet™ B in the formulation increased. FIG. 13 illustrates a Fourier-transform infrared spectroscopy (FTIR) spectrum of SMA-I and quaternized SMA-I (SMA_{Quat} 725). FIG. 14 is an ¹H NMR spectra of SMA-I and SMA_{Quat} 725 products. Analysis performed in DMSO-d₆, 400 MHz. Star indicates redsidual solvent. FIG. 11. ¹³C NMR spectra of SMA-I and SMA_{Quat} 725 products. Analysis performed in DMSO-d₆, 400 MHz. Star indicates solvent. Residual dimethylformamide observed at 35.7 and 30.7 ppm. FIG. 16 is an FTIR of [SMA_{Quat} 725]I FTIR (cm⁻¹): 3381, 3027, 2937, 2857, 1769, 1690,1490, 1452, 1400, 1349, 1180, 1141, 1027, 962, 919, 759, 699. FIG. 17 is an 1H NMR spectra of SMA_{Quat} 725 I. Analysis performed in DMSO-d₆. ¹H NMR (400 MHz, DMSO-d₆): 7.11, 7.09, 6.63, 5.36, 5.35, 5.34, 3.91, 3.35, 3.10, 3.07, 3.07, 3.06, 2.99, 2.96, 2.73, 2.27, 2.25, 2.23, 1.97, 1.96, 1.86, 1.85, 1.80, 1.77, 1.77, 1.75, 1.74, 1.74, 1.64, 1.54. FIG. 18 is a ¹³C NMR spectra of SMA_{Quat} 725 I. Analysis performed in DMSO-d₆. ¹³C NMR (100 MHz, DMSO-d₆): 210.8, 210.3, 136.1, 128.1, 122.4, 70.6, 62.7, 57.6, 52.2, 43.0, 41.6, 41.3, 34.5, 31.4, 27.8, 27.1, 26.6, 26.4, 24.7, 24.3, 24.3, 22.4, 22.0, 21.3. FIG. 19 is an FT-IR spectra of SMA_{Quat} 725 Cl. FTIR (cm⁻¹): 3440, 3362, 3324, 3302, 3273, 3025, 2926, 2855, 1769, 1694, 1493, 1452, 1402, 1351, 1180, 1141, 1027, 964, 919, 755, 699. FIG. 20 is an ¹H NMR spectra of SMA_{Quat} 725 Cl. Analysis performed in DMSO-d₆. ¹H NMR (400 MHz, DMSO-d₆): 7.10, 6.62, 5.34, 3.91, 3.34, 3.13, 3.09, 3.06, 3.00, 2.27, 2.25, 2.23, 1.96, 1.86, 1.85, 1.77, 1.77, 1.75, 1.74, 1.72, 1.65, 1.64, 1.54, 1.53. FIG. 21 is a ¹³C NMR spectra of SMA_{Quat} 725 Cl. Analysis performed in DMSO-d₆. ¹³C NMR (100 MHz, DMSO-d₆): 210.8, 210.3, 136.1, 122.5, 57.7, 52.1, 41.6, 41.3, 31.4, 27.1, 26.7, 26.4, 24.7, 24.3, 24.3, 22.4, 22.0, 20.9.

### Example 10: Addition of Cationic Polymer Surfactant Aggregate with Polymer with Different End Groups Provide Improvement in Performance of Cationic Polyacrylamide

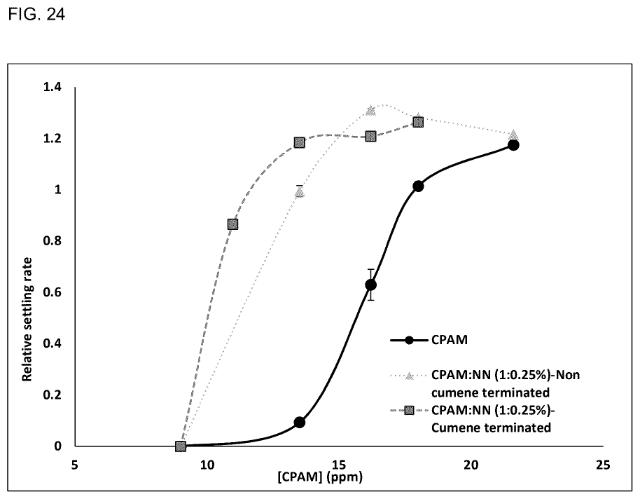

The results of Example 10 are shown in FIG. 24. FIG. 24 illustrates the relative settling rate of high charge CPAM 4808SSH and NN_{A} at 1:0.25 ratio of NanoNet™ dosed in diluted water matrix A. In this example, NN_{A} contains similar formulation of [SMA_{Quat} 725]:[TX305]:[PG3-C]5:2.5:2 with different cationic polymer end groups namely, SMA_{Quat} 725 non-cumene terminated and SMA_{Quat} 725 cumene terminated, respectively. The results suggest a 37.5% improvement in the performance of CPAM:NN_{A} prepared with cumene-terminated SMA_{Quat} 725 and 32.8% improvement in the performance of CPAM:NN_{A} prepared with non-cumene terminated SMA_{Quat} 725. Improvement in performance is compared to CPAM alone in order to achieve the same relative settling rate (calculated based on ppm relative settling rates at different CPAM dosing).

### Example 11: Enhanced Flocculation Performance of Cationic Polyacrylamide with High Charge Density Upon Addition of NanoNet™ Containing Cationic Polymers with Different Hydrophobic:Hydrophilic Ratios with Similar Surfactant Aggregate

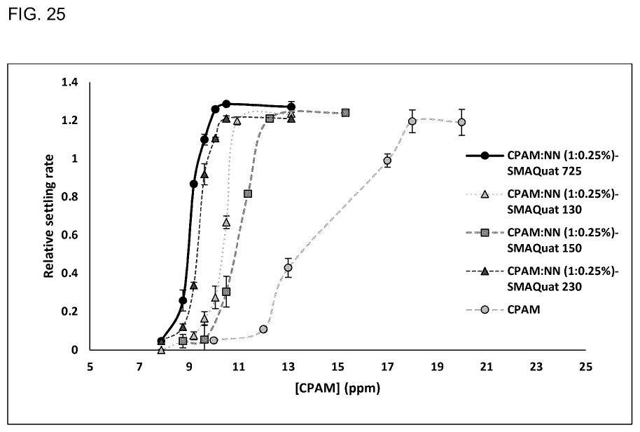

FIG. 25 illustrates the relative settling rate of high charge CPAM CP911H and NN_{A} at 1:0.25 ratio of CPAM:NanoNet™ dosed in diluted water matrix A. The effect of different hydrophobic:hydrophilic ratios in the SMA_{Quat} polymer formulated in NN_{A} is investigated herein, where SMA_{Quat} 725 has a ratio of 3:1 and molecular weight of at least 100,000 Da, SMA_{Quat} 130 has a ratio of 2:1 and molecular weight of at least 7,500 Da, SMA_{Quat} 150 has a ratio of 1:1 and molecular weight of at least 5,500 Da, SMA_{Quat} 230 has a ratio of 2:1 and molecular weight of at least 27,000 Da. NN_{A} contains similar formulation of [SMA_{Quat} X]:[TX305]:[PG3-C](with SMA_{Quat}X, X being 725, 230, 130, 150) (being 5:2.5:2. Comparing the settling rate vs. dose of CPAM to the CPAM:NN_{A} blends, NN_{A} containing SMA_{Quat} 725 displays 44% improved performance upon addition, 41.6% performance boost upon addition of NN_{A} containing SMA_{Quat} 230, 39.2% performance boost upon addition of NN_{A} containing SMA_{Quat} 130, and 27.2% performance boost upon addition of NN_{A} containing SMA_{Quat} 150, respectively.

### Example 12: Formulation of Cationic Polymer Surfactant Aggregate with Sustainable Surfactant

TABLE 10

| | | | Turbidity |
|---|---|---|---|
| | | Particle | removal |
| [polymer]:[Sustainable Surfactant] | | Size, nm | of kaolin, % |
| [SMA_{Quat} 725]:[TG 15-S-20] | 5:0.5 | 33.18 | 96.0 |
| | 5:1 | 35.53 | 96.5 |
| | 5:1.5 | 44.33 | 97.0 |
| | 5:2 | 26.25 | 97.3 |
| | 5:2.5 | 25.29 | 96.8 |
| [SMA_{Quat} 725]:[TG 15-S-40] | 5:0.5 | 34.83 | 96.7 |
| | 5:1 | 31.97 | 97.1 |
| | 5:1.5 | 30.96 | 96.1 |
| | 5:2 | 28.89 | 96.0 |
| | 5:2.5 | 28.46 | 95.9 |
| [SMA_{Quat} 725]:[BS N91-8] | 5:0.5 | 42.60 | 97.5 |
| | 5:1 | 44.34 | 97.7 |
| | 5:1.5 | 46.73 | 97.8 |
| | 5:2* | 110.52 | 97.4 |
| | 5:2.5* | 120.73 | 97.2 |

*Aggregated

Table 10 provides evidence of the interaction of SMA_{Quat} 725 5% with different biodegradable surfactants to form green NanoNet™. Turbidity removal is tested in 0.3% kaolin and reduction in the turbidity after settling was reported. The HLB value of TG 15-S-20 is 15.6 and of TG 15-S-40 is 18 (Gala Marti, V., Coenen, A., & Schörken, U. (2021). Synthesis of linoleic acid 13-hydroperoxides from safflower oil utilizing lipoxygenase in a coupled enzyme system with in-situ oxygen generation. Catalysts, 11(9), 1119), and of BS N91-8 is 13.9. The high HLB surfactants TG 15-S-40 and TG 15-S-20 provided stable and small particle diameters (approximately 25 nm and 28 nm, respectively, Table 10). It was found that NanoNet™ system containing surfactant BS N91-8 showed signs of gelation at higher ratios greater than [SMA_{Quat} 725]:[BS N91-8]5:2.

Overall, results shown in Table 10 confirm that surfactant with HLB>15 are applicable as stabilizing surfactants. Surfactants with HLB<15 are not an effective stabilizing surfactant.

### Example 13: Formulation of Sustainable Cationic NanoNet™ with Stabilizing Surfactant and Size Modifying Surfactant

TABLE 11

| | | | Turbidity |
|---|---|---|---|
| [Polymer]:[Stabilizing Surfactant]:[Size | | Particle | removal of |
| Modifying Surfactant] | | Size, nm | kaolin, % |
| [SMA_{Quat} 725]:[TG | 5:0.5:2 | 59.82 | 98.5 |
| 15-S-40]:[PG3-C] | 5:1:2 | 47.93 | 98.6 |
| | 5:1.5:2 | 42.90 | 98.1 |
| | 5:2:2 | 34.18 | 98.2 |
| | 5:2.5:2 | 33.70 | 97.0 |
| [SMA_{Quat} 725]:[TG | 5:0.5:2.5 | 50.73 | 95.5 |
| 15-S-40]:[APG] | 5:1:2.5 | 48.37 | 95.2 |
| | 5:1.5:2.5 | 44.38 | 94.1 |
| | 5:2:2.5 | 44.25 | 93.8 |
| | 5:2.5:2.5 | 45.53 | 93.5 |

To form balanced sustainable NanoNets™-7 APG (Triton™ CG-110) and PG3-C were selected as size modifying surfactants each at 2.5% due to their sustainability and biodegradability, low HLB value, high turbidity removal and large particle aggregate diameter in the experiments presented in Table 8. The surfactant TG 15-S-40 was selected due to its green nature and biodegradability, high HLB value, strong stabilizing effect and small particle size as a stabilizing surfactant. The HLB value of TG 15-S-40 is 18. The very high HLB value of this surfactant is expected to facilitate the generation of a stable NanoNet™. Thus, systems containing SMA_{Quat} 725, TG 15-S-40 and APG (as stabilizing surfactant and size modifying surfactant, respectively) and SMA_{Quat} 725, TG 15-S-40 and PG3-C (as stabilizing surfactant and size modifying surfactant, respectively) were formed, Table 11. Turbidity removal is tested in 0.3% kaolin and reduction in the turbidity after settling was reported.

Overall, results shown in Table 11 indicate that green NanoNets™ are formed with various sustainable surfactants if HLB value of stabilizing surfactant>15 and size modifying surfactant<14.

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Numeric ranges are inclusive of the numbers defining the range. Furthermore, numeric ranges are provided so that the range of values is recited in addition to the individual values within the recited range being specifically recited in the absence of the range. The word “comprising” is used herein as an open-ended term, substantially equivalent to the phrase “including, but not limited to”, and the word “comprises” has a corresponding meaning. As used herein, the singular forms “a”, “an” and “the” include plural references unless the context clearly dictates otherwise. Thus, for example, reference to “a thing” includes more than one such thing. Citation of references herein is not an admission that such references are prior art to the present invention. Furthermore, material appearing in the background section of the specification is not an admission that such material is prior art to the invention. Any priority document(s) are incorporated herein by reference as if each individual priority document were specifically and individually indicated to be incorporated by reference herein and as though fully set forth herein. The invention includes all embodiments and variations substantially as hereinbefore described and with reference to the examples and drawing.

1. A composition comprising
a) a cationic block co-polymer; and
b) a cationic polyacrylamide, the cationic polyacrylamide having a charge density in a range of from 2% to 100%.

2. The composition according to claim 1, wherein the cationic block co-polymer is selected from the group consisting of styrene carbamate block co-polymers, limonene carbamate block co-polymers, limonene maleimide block co-polymers, styrene maleimide block co-polymers, and combinations thereof.

3. The composition according to claim 1, wherein the cationic block co-polymer is an amphipathic polymer.

4. The composition according to claim 1, wherein the cationic block co-polymer has a molecular weight of at least 5,000 Da.

5. The composition according to claim 1, wherein the cationic block co-polymer has a molecular weight of at least 7,000 Da.

6. The composition according to claim 1, wherein the cationic block co-polymer has a molecular weight of at least 27,000 Da.

7. The composition according to claim 1, wherein the cationic block co-polymer has a molecular weight of at least 100,000 Da.

8. The composition according to claim 1, wherein the cationic block co-polymer comprises a ratio of hydrophobic:hydrophilic groups of about 3:1.

9. The composition according to claim 1, wherein the cationic block co-polymer comprises a ratio of hydrophobic:hydrophilic groups of about 2:1.

10. The composition according to claim 1, wherein the cationic block co-polymer comprises a ratio of hydrophobic:hydrophilic groups of about 1:1.

11. The composition according to claim 1, wherein the cationic block co-polymer is SMA_{Quat}.

12. The composition according to claim 1, wherein the cationic block co-polymer is SMA_{Quat} 725, SMA_{Quat} 230, SMA_{Quat} 130, or SMA_{Quat} 150.

13. The composition according to claim 1, wherein the cationic block co-polymer is part of a cationic polymer surfactant aggregate and the polymer surfactant aggregate further comprises a stabilizing surfactant and a size modifying surfactant.

14. The composition according to claim 13, wherein the stabilizing surfactant, and the size modifying surfactant are each independently selected from at least one of:
i) a non-ionic surfactant;
ii) a cationic surfactant; and
iii) a zwitterionic surfactant.

15. The composition according to claim 13, wherein the stabilizing surfactant comprises at least one of an ethoxylated amine, a quaternary ammonium salt, polyoxyethylene (20) sorbitan monolaurate, polyoxyethylene (20) sorbitan monopalmitate, polyoxyethylene (20) sorbitan monostearate, polyoxyethylene (20) sorbitan monooleate, Tergitol™ 15-S-20, Tergitol™ 15-S-40, or 2-[4-(2,4,4-trimethylpentan-2-yl)phenoxy]ethanol (C₁₄H₂₂O(C₂H₄O)ₙ having the chemical formula: 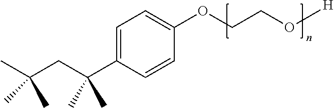
wherein n=4-5, 9, 10, or 30, or mixtures thereof.

16. The composition according to claim 13, wherein the size modifying surfactant is at least one selected from the group consisting ofan alkyl polyglucoside, lipid, oil, polyglycerol 3-caprylate, nonionic surfactants, sugar-derived surfactants, glycidyl-derived surfactants, fatty acid alcohol-derived surfactants, nonionic surfactants, saccharide polyethyleneoxide combination surfactants, saccharide ester surfactants, sulfonated sugar based surfactants, aldonamide based surfactants, amide sugar based surfactants, amino alcohol surfactants, amino acid based surfactants, polyol surfactants, 1,2 glycol surfactants, zwitterionic surfactants, and mixtures thereof.

17. The composition of claim 1, wherein the cationic polyacrylamide polymer has a charge density of from 10% to 100%.

18. The composition according to claim 1, wherein the cationic polyacrylamide polymer has a charge density of 2%-19%, 20-40%, 60-79%, 80-100%, and combinations thereof.

19. The composition according to claim 1, wherein the cationic polyacrylamide polymer has a charge density of 30%.

20. The composition according to claim 1, wherein the cationic polyacrylamide polymer has a charge density of 40%.

21. The composition according to claim 1, wherein the cationic polyacrylamide polymer has a charge density of 50%.

22. The composition according to claim 1, wherein the cationic polyacrylamide polymer has a charge density of 80%.

23. The composition according to claim 1, wherein the cationic polyacrylamide polymer has a charge density of 90%.

24. The composition according to claim 1, wherein the cationic polyacrylamide has a molecular weight in a range of from (2)10⁶ Da to (12)10⁶ Da.

25. The composition according to claim 1, wherein the cationic polyacrylamide has a molecular weight in a range of from (5)10⁶ Da to (12)10⁶ Da.

26. The composition according to claim 1, wherein the cationic polyacrylamide has a molecular weight in a range of from (5)10⁶ Da to (8)10⁶ Da.

27. The composition according to claim 1, wherein the cationic polyacrylamide polymer is selected from the group consisting of CPAM 835, CPAM 853, CPAM 611, CPAM 911, CPAM 911H, CPAM 4808SSH, and combinations thereof.

28. The composition according to claim 1, wherein the cationic polyacrylamide polymer is selected from the group consisting of CPAM 835, CPAM 853, CPAM 911, CPAM 911H, CPAM 4808SSH, and combinations thereof.

29. A method for removing solids from a solid-liquid mixture, the method comprising:
a) mixing a cationic polyacrylamide polymer with a cationic polymer surfactant aggregate, thereby forming a conditioned flocculant;
b) agitating the conditioned flocculant with the solid-liquid mixture, thereby forming an agitated mixture; and
c) removing solids from the agitated mixture.

30. The method of claim 29, further comprising mixing a stabilizing surfactant with the cationic polymer surfactant aggregate.

31. The method according to claim 30, wherein mixing the stabilizing surfactant with the cationic polymer surfactant aggregate occurs prior to mixing the cationic polyacrylamide polymer with the cationic polymer surfactant aggregate.

32. The method according to claim 30, wherein mixing the stabilizing surfactant with the cationic polymer surfactant aggregate and mixing the cationic polyacrylamide polymer with the cationic polymer surfactant aggregate occur concurrently.

33. The method of claim 29, further comprising mixing a size modifying surfactant with the cationic polymer surfactant aggregate.

34. A method for removing solids from a solid-liquid mixture, the method comprising:
a) adding a composition according to claim 1 to the solid-liquid mixture;
b) agitating the solid liquid mixture together with the composition, thereby forming an agitated mixture; and
c) removing solids from the agitated mixture.

35. The method according to claim 34, wherein the removing solids comprises at least one selected from the group consisting of: filtration, centrifugation, gravity separation, flotation, skimming, and electromagnetic attraction.
